(19) United States
(12) Patent Application Publication
(10) Pub. No.: US 2026/0322513 A1
(43) Pub. Date: Oct. 15, 2026

(54) APPARATUSES AND METHODS FOR ERROR VECTOR MAGNITUDE ESTIMATION AND REPORTING

(71) Applicant: QUALCOMM Incorporated, San Diego, CA (US)

(72) Inventors: Idan Michael HORN, Hod Hasharon (IL); Shay LANDIS, Hod Hasharon (IL); Yehonatan DALLAL, Kfar Saba (IL); Amit BAR-OR TILLINGER, Tel-Aviv (IL)

(21) Appl. No.: 19/481,849

(22) PCT Filed: May 22, 2024
(86) PCT No.: PCT/US2024/030503

§ 371 Date: Nov. 5, 2025

(30) Foreign Application Priority Data
Jun. 15, 2023 (IL) 303760

(51) Int. Cl. H04B 17/309; H04L 5/00; H04W 8/22

(52) U.S. Cl. CPC H04B 17/346; H04L 5/0051; H04W 8/22

(57) ABSTRACT

Methods, systems, and devices for wireless communications are described. The described techniques provide for a receiving device to estimate an error vector magnitude (EVM) associated with each antenna port of a transmitting device and reporting the EVM to the transmitting device to improve communication throughput. The receiving device may receive a respective pilot signal from each antenna port of the transmitting device and may estimate, according to a distortion value associated with each respective pilot signal, an EVM for each antenna port. In some examples, the receiving device may isolate a distortion value from a pilot signal according to a channel response measurement of the pilot signal and a channel noise estimation of a wireless channel between the transmitting device and the receiving device. Additionally, or alternatively, the receiving device may use maximum-ratio combining (MRC) techniques to identify the transmitter EVM.

### CROSS REFERENCE

The present application for patent is a 371 national phase filing of International Patent Application No. PCT/US2024/030503 by HORN et al., entitled “APPARATUSES AND METHODS FOR ERROR VECTOR MAGNITUDE ESTIMATION AND REPORTING,” filed May 22, 2024, which claims priority to Israel Patent Application No. 303760 by HORN et al., entitled “APPARATUSES AND METHODS FOR ERROR VECTOR MAGNITUDE ESTIMATION AND REPORTING,” filed Jun. 15, 2023, each of which is assigned to the assignee hereof, and each of which is expressly incorporated by reference in its entirety herein.

### FIELD OF TECHNOLOGY

The following relates to wireless communications, including error vector magnitude estimation and reporting.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM). A wireless multiple-access communications system may include one or more base stations, each supporting wireless communication for communication devices, which may be known as user equipment (UE).

Communication links in a wireless communications system may be subject to various sources of signal degradation including channel noise, channel gain, and distortion associated with a transmitter. Enhancement to efficient use of wireless communication resources may present challenges in light of the different sources of signal degradation.

### SUMMARY

The described techniques relate to improved methods, systems, devices, and apparatuses that support error vector magnitude (EVM) estimation and reporting. For example, the described techniques provide for a receiving device to estimate an EVM associated with each antenna port of a transmitting device and reporting the EVM to the transmitting device. For example, the receiving device may receive a respective pilot signal from each antenna port of the transmitting device and may estimate, according to a distortion value associated with each respective pilot signal, an EVM for each antenna port. In some examples, the receiving device may isolate a distortion value from a pilot signal according to a channel response measurement of the pilot signal and a channel noise estimation of a wireless channel between the transmitting device and the receiving device. For example, the receiving device may leverage an estimated noise of a known signal and an estimated noise in the absence of a signal to obtain a transmitter noise covariance matrix, which may indicate the distortion value associated with a transmitter antenna port. Additionally, or alternatively, the receiving device may use maximum-ratio combining (MRC) techniques to identify the transmitter EVM, which may be based on a quantity of antennas associated with the receiving device.

A method for wireless communications at a user equipment (UE) is described. The method may include receiving, from a network entity, one or more reference signals via one or more antenna ports of the UE, each reference signal of the one or more reference signals corresponding to a respective antenna port of the one or more antenna ports and transmitting, to the network entity, a message including one or more distortion values, each distortion value of the one or more distortion values corresponding to measured distortion associated with a respective reference signal of the one or more reference signals, where the one or more distortion values are independent of an interference associated with a wireless channel between the UE and the network entity.

An apparatus for wireless communications at a UE is described. The apparatus may include at least one processor, at least one memory coupled with the at least one processor, and instructions stored in the at least one memory. The instructions may be executable by the at least one processor to cause the apparatus to receive, from a network entity, one or more reference signals via one or more antenna ports of the UE, each reference signal of the one or more reference signals corresponding to a respective antenna port of the one or more antenna ports and transmit, to the network entity, a message including one or more distortion values, each distortion value of the one or more distortion values corresponding to measured distortion associated with a respective reference signal of the one or more reference signals, where the one or more distortion values are independent of an interference associated with a wireless channel between the UE and the network entity.

Another apparatus for wireless communications at a UE is described. The apparatus may include means for receiving, from a network entity, one or more reference signals via one or more antenna ports of the UE, each reference signal of the one or more reference signals corresponding to a respective antenna port of the one or more antenna ports and means for transmitting, to the network entity, a message including one or more distortion values, each distortion value of the one or more distortion values corresponding to measured distortion associated with a respective reference signal of the one or more reference signals, where the one or more distortion values are independent of an interference associated with a wireless channel between the UE and the network entity.

A non-transitory computer-readable medium storing code for wireless communications at a UE is described. The code may include instructions executable by a processor to receive, from a network entity, one or more reference signals via one or more antenna ports of the UE, each reference signal of the one or more reference signals corresponding to a respective antenna port of the one or more antenna ports and transmit, to the network entity, a message including one or more distortion values, each distortion value of the one or more distortion values corresponding to measured distortion associated with a respective reference signal of the one or more reference signals, where the one or more distortion values are independent of an interference associated with a wireless channel between the UE and the network entity.

Some examples of the method, apparatuses, and non-transitory computer-readable medium described herein may further include operations, features, means, or instructions for measuring a respective first noise value using each antenna port of the one or more antenna ports, where each of the respective first noise values corresponds to a measurement of the wireless channel that may be not carrying the one or more reference signals and measuring a respective second noise value using each antenna port of the one or more antenna ports, where each of the respective second noise values corresponds to an estimated noise associated with each respective reference signal of the one or more reference signals, and where a respective distortion value of the one or more distortion values may be determined based on a function of the respective first noise value and the respective second noise value.

Some examples of the method, apparatuses, and non-transitory computer-readable medium described herein may further include operations, features, means, or instructions for obtaining, for the one or more antenna ports, respective first noise covariances based on the respective first noise values and respective second noise covariances based on the respective second noise values and obtaining the one or more distortion values based on the respective first noise covariances, the respective second noise covariances, and respective estimations of respective channels between the network entity and the one or more antenna ports.

In some examples of the method, apparatuses, and non-transitory computer-readable medium described herein, the one or more distortion values may be determined according to a MRC procedure and the MRC procedure may be based on a quantity of the one or more antenna ports of the UE.

Some examples of the method, apparatuses, and non-transitory computer-readable medium described herein may further include operations, features, means, or instructions for estimating a channel response of the wireless channel using a first antenna port of the one or more antenna ports based on decoding data associated with a first reference signal of the one or more reference signals, the first antenna port corresponding to the first reference signal, where a first distortion value of the one or more distortion values associated with the first reference signal may be based on the estimated channel response.

Some examples of the method, apparatuses, and non-transitory computer-readable medium described herein may further include operations, features, means, or instructions for receiving an indication that the UE may be to perform an EVM estimation procedure, where receiving the one or more reference signals may be based on receiving the indication.

Some examples of the method, apparatuses, and non-transitory computer-readable medium described herein may further include operations, features, means, or instructions for receiving the indication may be based on a change in an EVM associated with the network entity, a change in one or more channel conditions associated with the wireless channel, a noise limitation associated with the UE, or a combination thereof.

In some examples of the method, apparatuses, and non-transitory computer-readable medium described herein, each reference signal of the one or more reference signals includes a channel state information reference signal (CSI-RS) or a demodulation reference signal (DMRS).

In some examples of the method, apparatuses, and non-transitory computer-readable medium described herein, each reference signal of the one or more reference signals includes a transport block that may be encoded onto a shared data channel.

In some examples of the method, apparatuses, and non-transitory computer-readable medium described herein, receiving the one or more reference signals may include operations, features, means, or instructions for receiving the one or more reference signals via one or more frequency resources dedicated to performing EVM estimation.

In some examples of the method, apparatuses, and non-transitory computer-readable medium described herein, receiving the one or more reference signals may include operations, features, means, or instructions for receiving the one or more reference signals via a bandwidth associated with the wireless channel, each reference signal of the one or more reference signals spanning across the bandwidth and receiving each reference signal of the one or more reference signals via a respective bandwidth part of the bandwidth.

In some examples of the method, apparatuses, and non-transitory computer-readable medium described herein, each antenna port of the one or more antenna ports may be configured according to a frequency domain duplexing (FDD) pattern, a time domain duplexing (TDD) pattern, or both.

In some examples of the method, apparatuses, and non-transitory computer-readable medium described herein, the message includes a media access control control element (MAC-CE) or a radio resource control (RRC) signal and the message may be a periodic message or an aperiodic message.

In some examples of the method, apparatuses, and non-transitory computer-readable medium described herein, each distortion value of the one or more distortion values includes a decibel value, a percentage, a difference between the measured distortion of the respective reference signal and a prior distortion measurement using the respective antenna port, a difference between the measured distortion of the respective reference signal and a second measured distortion of a second reference signal of the one or more reference signals, or a combination thereof.

Some examples of the method, apparatuses, and non-transitory computer-readable medium described herein may further include operations, features, means, or instructions for receiving one or more signals from the network entity based on transmitting the message, where an output power, a waveform, a rank, a precoding configuration, a beamforming configuration, or any combination thereof associated with the one or more signals may be based on the one or more distortion values.

A method for wireless communications at a network entity is described. The method may include receiving, from a UE, one or more reference signals via one or more antenna ports of the network entity, each reference signal of the one or more reference signals corresponding to a respective antenna port of the one or more antenna ports and transmitting, to the UE, a configuration for transmitting one or more signals based on one or more distortion values, each distortion value of the one or more distortion values corresponding to measured distortion associated with a respective reference signal of the one or more reference signals, where the one or more distortion values are independent of an interference associated with a wireless channel between the UE and the network entity.

An apparatus for wireless communications at a network entity is described. The apparatus may include at least one processor, at least one memory coupled with the at least one processor, and instructions stored in the at least one memory. The instructions may be executable by the at least one processor to cause the apparatus to receive, from a UE, one or more reference signals via one or more antenna ports of the network entity, each reference signal of the one or more reference signals corresponding to a respective antenna port of the one or more antenna ports and transmit, to the UE, a configuration for transmitting one or more signals based on one or more distortion values, each distortion value of the one or more distortion values corresponding to measured distortion associated with a respective reference signal of the one or more reference signals, where the one or more distortion values are independent of an interference associated with a wireless channel between the UE and the network entity.

Another apparatus for wireless communications at a network entity is described. The apparatus may include means for receiving, from a UE, one or more reference signals via one or more antenna ports of the network entity, each reference signal of the one or more reference signals corresponding to a respective antenna port of the one or more antenna ports and means for transmitting, to the UE, a configuration for transmitting one or more signals based on one or more distortion values, each distortion value of the one or more distortion values corresponding to measured distortion associated with a respective reference signal of the one or more reference signals, where the one or more distortion values are independent of an interference associated with a wireless channel between the UE and the network entity.

A non-transitory computer-readable medium storing code for wireless communications at a network entity is described. The code may include instructions executable by a processor to receive, from a UE, one or more reference signals via one or more antenna ports of the network entity, each reference signal of the one or more reference signals corresponding to a respective antenna port of the one or more antenna ports and transmit, to the UE, a configuration for transmitting one or more signals based on one or more distortion values, each distortion value of the one or more distortion values corresponding to measured distortion associated with a respective reference signal of the one or more reference signals, where the one or more distortion values are independent of an interference associated with a wireless channel between the UE and the network entity.

Some examples of the method, apparatuses, and non-transitory computer-readable medium described herein may further include operations, features, means, or instructions for receiving, from the UE, a capability report indicating a capability of the UE to transmit the one or more reference signals via one or more bandwidth parts of a bandwidth associated with the wireless channel.

In some examples of the method, apparatuses, and non-transitory computer-readable medium described herein, the configuration indicates one or more physical layer parameters for transmitting the one or more signals, the one or more physical layer parameters including a precoding configuration, a quantity of spatial layers, or both.

Some examples of the method, apparatuses, and non-transitory computer-readable medium described herein may further include operations, features, means, or instructions for receiving, from the UE, a request to perform an EVM estimation procedure, where receiving the one or more reference signals may be based on receiving the request.

In some examples of the method, apparatuses, and non-transitory computer-readable medium described herein, each reference signal of the one or more reference signals includes a CSI-RS or a DMRS.

In some examples of the method, apparatuses, and non-transitory computer-readable medium described herein, each reference signal of the one or more reference signals includes a transport block that may be encoded onto a shared data channel.

### BRIEF DESCRIPTION OF THE DRAWINGS

FIG. 1 shows an example of a wireless communications system that supports error vector magnitude (EVM) estimation and reporting in accordance with one or more aspects of the present disclosure.

FIGS. 2A and 2B show examples of wireless communications systems that support EVM estimation and reporting in accordance with one or more aspects of the present disclosure.

FIG. 3 shows an example of a process flow that supports EVM estimation and reporting in accordance with one or more aspects of the present disclosure.

FIG. 4 shows an example of a process flow that supports EVM estimation and reporting in accordance with one or more aspects of the present disclosure.

FIGS. 5 and 6 show block diagrams of devices that support EVM estimation and reporting in accordance with one or more aspects of the present disclosure.

FIG. 7 shows a block diagram of a communications manager that supports EVM estimation and reporting in accordance with one or more aspects of the present disclosure.

FIG. 8 shows a diagram of a system including a device that supports EVM estimation and reporting in accordance with one or more aspects of the present disclosure.

FIGS. 9 and 10 show block diagrams of devices that support EVM estimation and reporting in accordance with one or more aspects of the present disclosure.

FIG. 11 shows a block diagram of a communications manager that supports EVM estimation and reporting in accordance with one or more aspects of the present disclosure.

FIG. 12 shows a diagram of a system including a device that supports EVM estimation and reporting in accordance with one or more aspects of the present disclosure.

FIGS. 13 and 14 show flowcharts illustrating methods that support EVM estimation and reporting in accordance with one or more aspects of the present disclosure.

### DETAILED DESCRIPTION

In some wireless communications systems, a wireless device may communicate via multiple antenna ports. In some cases, each antenna port may be associated with a respective error vector magnitude (EVM), which may incur distortion in transmissions from the antenna port. For example, a transmitting device may transmit a modulated symbol (e.g., according to a quadrature amplitude modulation (QAM) scheme) and a receiving device may receive a distorted symbol (e.g., a deviation on the QAM constellation) due to the EVM of the transmitting device. In some examples, identifying the EVM associated with each antenna port of the transmitting device may enable the transmitting device to adjust one or more physical layer parameters to improve communication throughput. However, EVM may be subject to change according to various communication parameters (e.g., temperature, link conditions, data precoding information, or a rank of data, among other examples), which may increase a complexity when mitigating the effects of EVM. Additionally, or alternatively, reporting mechanisms for communicating EVM information may be undefined, which may incur latency when attempting to identify the EVM.

To support EVM determination for a transmitting device, a receiving device may estimate an EVM associated with each antenna port of the transmitting device and may report the EVM to the transmitting device. For example, the receiving device may receive a respective pilot signal (e.g., reference signal) from each antenna port of the transmitting device and may estimate, according to a distortion value associated with each respective pilot signal, an EVM for each antenna port. In some examples, the receiving device may isolate a distortion value from a pilot signal according to a channel response measurement of the pilot signal and a channel noise estimation of a wireless channel between the transmitting device and the receiving device. For example, the receiving device may leverage an estimated noise of a known signal (e.g., the pilot signal) and an estimated noise in the absence of a signal (e.g., a noise of a same beam or channel used to transmit the signal) to obtain a transmitter noise covariance matrix, which may indicate the distortion value associated with a transmitter antenna port. Additionally, or alternatively, the receiving device may use maximum-ratio combining (MRC) techniques to identify the transmitter EVM, which may be based on a quantity of antennas associated with the receiving device. Such techniques may support EVM estimation and reporting, and may improve communication throughput, in downlink scenarios (e.g., a transmitting network entity and a receiving user equipment (UE)) and in uplink scenarios (e.g., a transmitting UE and a receiving network entity).

Aspects of the disclosure are initially described in the context of wireless communications systems. Aspects of the disclosure are further illustrated by and described with reference to process flows. Aspects of the disclosure are further illustrated by and described with reference to apparatus diagrams, system diagrams, and flowcharts that relate to EVM estimation and reporting.

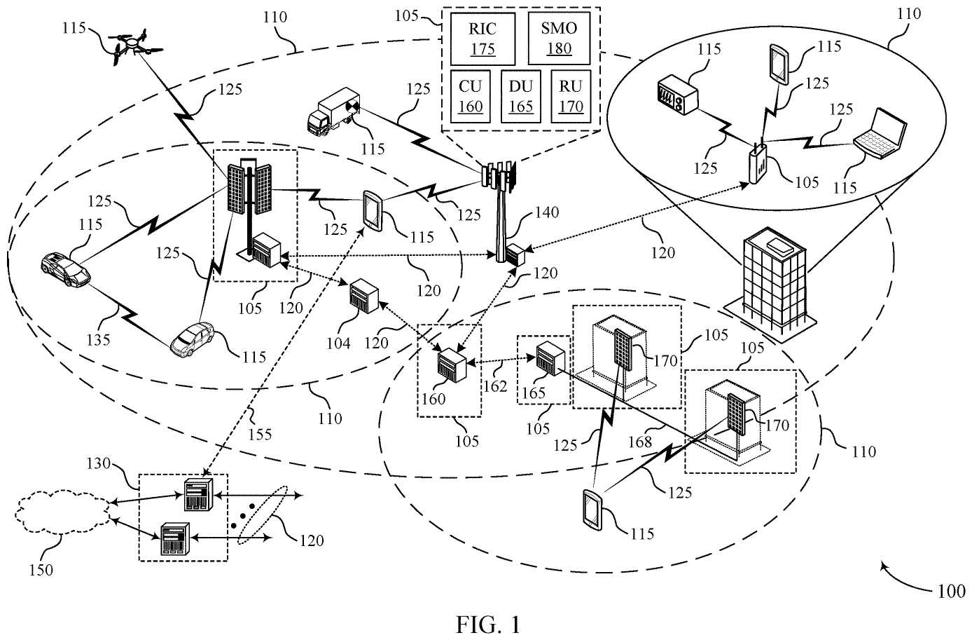

FIG. 1 shows an example of a wireless communications system 100 that supports EVM estimation and reporting in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, a node of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

For instance, an access network (AN) or RAN may include communications between access nodes (e.g., an IAB donor), IAB nodes 104, and one or more UEs 115. The IAB donor may facilitate connection between the core network 130 and the AN (e.g., via a wired or wireless connection to the core network 130). That is, an IAB donor may refer to a RAN node with a wired or wireless connection to core network 130. The IAB donor may include a CU 160 and at least one DU 165 (e.g., and RU 170), in which case the CU 160 may communicate with the core network 130 via an interface (e.g., a backhaul link). IAB donor and IAB nodes 104 may communicate via an F1 interface according to a protocol that defines signaling messages (e.g., an F1 AP protocol). Additionally, or alternatively, the CU 160 may communicate with the core network via an interface, which may be an example of a portion of backhaul link, and may communicate with other CUs 160 (e.g., a CU 160 associated with an alternative IAB donor) via an Xn-C interface, which may be an example of a portion of a backhaul link.

An IAB node 104 may refer to a RAN node that provides IAB functionality (e.g., access for UEs 115, wireless self-backhauling capabilities). A DU 165 may act as a distributed scheduling node towards child nodes associated with the IAB node 104, and the IAB-MT may act as a scheduled node towards parent nodes associated with the IAB node 104. That is, an IAB donor may be referred to as a parent node in communication with one or more child nodes (e.g., an IAB donor may relay transmissions for UEs through one or more other IAB nodes 104). Additionally, or alternatively, an IAB node 104 may also be referred to as a parent node or a child node to other IAB nodes 104, depending on the relay chain or configuration of the AN. Therefore, the IAB-MT entity of IAB nodes 104 may provide a Uu interface for a child IAB node 104 to receive signaling from a parent IAB node 104, and the DU interface (e.g., DUs 165) may provide a Uu interface for a parent IAB node 104 to signal to a child IAB node 104 or UE 115.

For example, IAB node 104 may be referred to as a parent node that supports communications for a child IAB node, or referred to as a child IAB node associated with an IAB donor, or both. The IAB donor may include a CU 160 with a wired or wireless connection (e.g., a backhaul communication link 120) to the core network 130 and may act as parent node to IAB nodes 104. For example, the DU 165 of IAB donor may relay transmissions to UEs 115 through IAB nodes 104, or may directly signal transmissions to a UE 115, or both. The CU 160 of IAB donor may signal communication link establishment via an F1 interface to IAB nodes 104, and the IAB nodes 104 may schedule transmissions (e.g., transmissions to the UEs 115 relayed from the IAB donor) through the DUs 165. That is, data may be relayed to and from IAB nodes 104 via signaling via an NR Uu interface to MT of the IAB node 104. Communications with IAB node 104 may be scheduled by a DU 165 of IAB donor and communications with IAB node 104 may be scheduled by DU 165 of IAB node 104.

In the case of the techniques described herein applied in the context of a disaggregated RAN architecture, one or more components of the disaggregated RAN architecture may be configured to support EVM estimation and reporting as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

One or more numerologies for a carrier may be supported, and a numerology may include a subcarrier spacing (Δf) and a cyclic prefix. A carrier may be divided into one or more BWPs having the same or different numerologies. In some examples, a UE 115 may be configured with multiple BWPs. In some examples, a single BWP for a carrier may be active at a given time and communications for the UE 115 may be restricted to one or more active BWPs.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

In some systems, a D2D communication link 135 may be an example of a communication channel, such as a sidelink communication channel, between vehicles (e.g., UEs 115). In some examples, vehicles may communicate using vehicle-to-everything (V2X) communications, vehicle-to-vehicle (V2V) communications, or some combination of these. A vehicle may signal information related to traffic conditions, signal scheduling, weather, safety, emergencies, or any other information relevant to a V2X system. In some examples, vehicles in a V2X system may communicate with roadside infrastructure, such as roadside units, or with the network via one or more network nodes (e.g., network entities 105, base stations 140, RUs 170) using vehicle-to-network (V2N) communications, or with both.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may also operate using a super high frequency (SHF) region, which may be in the range of 3 GHz to 30 GHz, also known as the centimeter band, or using an extremely high frequency (EHF) region of the spectrum (e.g., from 30 GHz to 300 GHz), also known as the millimeter band. In some examples, the wireless communications system 100 may support millimeter wave (mmW) communications between the UEs 115 and the network entities 105 (e.g., base stations 140, RUs 170), and EHF antennas of the respective devices may be smaller and more closely spaced than UHF antennas. In some examples, such techniques may facilitate using antenna arrays within a device. The propagation of EHF transmissions, however, may be subject to even greater attenuation and shorter range than SHF or UHF transmissions. The techniques disclosed herein may be employed across transmissions that use one or more different frequency regions, and designated use of bands across these frequency regions may differ by country or regulating body.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

The network entities 105 or the UEs 115 may use MIMO communications to exploit multipath signal propagation and increase spectral efficiency by transmitting or receiving multiple signals via different spatial layers. Such techniques may be referred to as spatial multiplexing. The multiple signals may, for example, be transmitted by the transmitting device via different antennas or different combinations of antennas. Likewise, the multiple signals may be received by the receiving device via different antennas or different combinations of antennas. Each of the multiple signals may be referred to as a separate spatial stream and may carry information associated with the same data stream (e.g., the same codeword) or different data streams (e.g., different codewords). Different spatial layers may be associated with different antenna ports used for channel measurement and reporting. MIMO techniques include single-user MIMO (SU-MIMO), for which multiple spatial layers are transmitted to the same receiving device, and multiple-user MIMO (MU-MIMO), for which multiple spatial layers are transmitted to multiple devices.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a channel state information reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a transmitting device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some cases, a wireless device (e.g., a network entity 105 or a UE 115) may communicate using multiple antenna ports. For example, a transmitting wireless device may transmit a respective data signal using each of multiple antenna ports. In some cases, a receiving device may identify that a data signal transmitted by an antenna port has distortion (e.g., a deviation from an expected QAM constellation symbol). Such distortion may be measured according to an EVM criteria, which may represent the distortion as a value (e.g., a decibel value, a percentage, a relative difference, or the like). In some cases, a source of the distortion may be related to a limitation of the transmitting device (e.g., an effective number of bits (ENOB) of a limited digital-to-analog converter (DAC)), a nonlinear response of radio frequency components, and clip and filtering techniques (e.g., crest factor reduction (CFR)), among other examples.

In some examples, the wireless device may communicate via a relatively large spectrum (e.g., in Sub-THz bands, such as FR5) to support applications with relatively large throughput, such as IAB applications, data center operations, or the like. To support communications via a large bandwidth with high output power, an EVM limit (e.g., allowable distortion) may be applied to the transmitting device. In some such cases, a throughput of the communications may be limited by the EVM of the transmitting device (e.g., as opposed to average white Gaussian noise (AWGN) at the receiving device). If the EVM is known by the transmitting device, the transmitting device may adjust one or more physical layer parameters (e.g., waveform, precoding method, or a quantity of layers, among other examples) to transmissions to improve the throughput. However, the EVM may vary according to one or more parameters (e.g., a temperature of an antenna port, wireless link conditions, a precoding scheme or rank of a transport block (TB), or any combination thereof), which may increase a complexity of identifying the EVM (e.g., in the case of a factory calibration).

To support EVM determination for a transmitting device, a receiving device may estimate an EVM associated with each antenna port of the transmitting device and may report the EVM to the transmitting device. For example, the receiving device may receive a respective pilot signal (e.g., reference signal) from each antenna port of the transmitting device and may estimate, according to a distortion value associated with each respective pilot signal, an EVM for each antenna port. In some examples, the receiving device may isolate a distortion value from a pilot signal according to a channel response measurement of the pilot signal and a channel noise estimation of a wireless channel between the transmitting device and the receiving device. For example, the receiving device may leverage an estimated noise of a known signal (e.g., the pilot signal) and an estimated noise in the absence of a signal (e.g., a noise of a same beam or channel used to transmit the signal) to obtain a transmitter noise covariance matrix, which may indicate the distortion value associated with a transmitter antenna port. Additionally, or alternatively, the receiving device may use maximum-ratio combining (MRC) techniques to identify the transmitter EVM, which may be based on a quantity of antennas associated with the receiving device. Such techniques may support the receiving device reporting an estimated EVM while suppressing interference of a channel associated with the communications (e.g., the distortion is identified from a same beam or channel as the data signal).

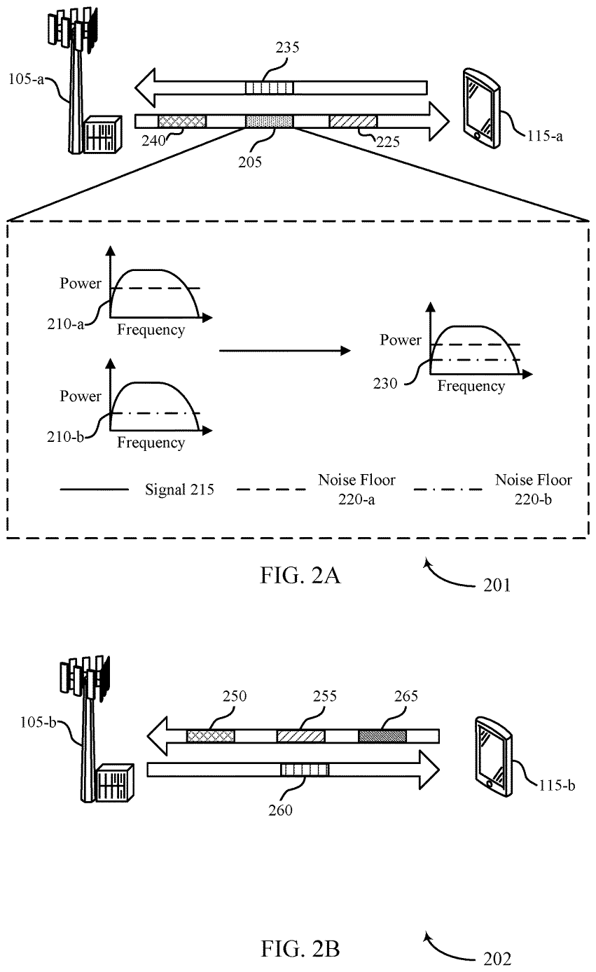

FIGS. 2A and 2B show examples of a wireless communications system 201 and 202, respectively, that support EVM estimation and reporting in accordance with one or more aspects of the present disclosure. In some cases, the wireless communications systems 201 and 202 may implement one or more aspects of the wireless communications system 100. For example, the wireless communications systems 201 and 202 may include a network entity 105-a and a UE 115-a, which may be examples of corresponding devices described with reference to FIG. 1. In some cases, the wireless communications system 201 and 202 may support EVM estimation and reporting by a receiving device in a downlink scenario (e.g., where the network entity 105-a is the transmitting device and the UE 115-a is the receiving device) and an uplink scenario (e.g., where the UE 115-a is the transmitting device and the network entity 105-a is the receiving device), respectively.

The wireless communications system 201 may support the network entity 105-a (e.g., a transmitting wireless device) identifying EVM associated with one or more antenna ports of the network entity 105-a according to a report from the UE 115-a (e.g., a receiving wireless device). In some cases, each antenna port of the network entity 105-a may be associated with a respective EVM. The network entity 105-a may transmit one or more reference signals 205 via respective antenna ports, which may be examples of dedicated pilot signals for EVM calculation. For example, the reference signals 205 may include a pilot signal 210-a and a pilot signal 210-b that correspond to a first antenna port and a second antenna port, respectively, of the network entity 105-a. In some cases, each pilot signal 210 may carry a signal 215 (e.g., data) and may have a respective noise floor 220. For example, the pilot signal 210-a may be associated with a noise floor 220-a (e.g., −23 dB) and the pilot signal 210-b may be associated with a noise floor 220-b (e.g., −21 dB), which may be different noise floor values (e.g., due to environmental parameters, such as a temperature of the antenna ports). It should be noted that the network entity 105-a may support any quantity of pilot signals 210 (and corresponding antenna ports), and is not limited to the quantity depicted in FIG. 2A.

In some cases, the network entity 105-a may transmit a message 225 to the UE 115-a to initiate EVM estimation (e.g., indicating that the UE 115-a is to perform EVM estimation and reporting). The network entity 105-a may determine to initiate the EVM estimation procedure according to a change in the EVM of the antenna ports of the network entity 105-a (e.g., a temperature change, or any other changes that may modify the EVM of the antenna ports), channel conditions of a wireless link between the network entity 105-a and the UE 115-a (e.g., if a precoding scheme, beamforming scheme, or both with rank optimization are limited by the transmitter EVM), non-receiver limited noise (e.g., if the UE 115-a is limited by the transmitter noise and the EVM impacts the signal-to-interference plus noise ratio (SINR)), or any combination thereof.

Additionally, or alternatively, the message 225 may indicate a type of the pilot signals 210 to the UE 115-a. For example, the message 225 may indicate that the pilot signals 210 are CSI-RSs, DMRSs, part of a TB encoded onto a shared data channel, any combination thereof, or other suitable channels. For example, pseudo-random data (e.g., generated according to a function and seed known by the UE 115-a) may be encoded as a TB and transmitted in a shared channel message. As another example, the network entity 105-a may indicate that the pilot signals 210 are dedicated to EVM calculation (e.g., a new pilot signal). For instance, the message 225 may indicate that the pilot signals 210 occupy a full bandwidth (e.g., without multiplexing with other channels, other time domain pilot signals, other frequency domain pilots, or the like). In some cases, the message 225 may indicate a resource allocation for the pilot signals 210. For example, the network entity 105-a may determine a frequency allocation for each pilot signal 210, which may indicate that each pilot signal 210 spans across a bandwidth of the wireless channel, may indicate that each pilot signal 210 is associated with a respective bandwidth part of the bandwidth (e.g., to estimate EVM for different parts of the bandwidth), or a combination thereof. In some examples, the message 225 may indicate whether the pilot signals 210 (e.g., and the antenna ports of the network entity 105-a) are configured according to an FDD pattern, a TDD pattern, or both. In some examples, the network entity 105-a may indicate, in the message 225, information (e.g., multiple hypotheses) of a precoding method, a beamforming scheme, or both associated with each antenna port (or virtual port) of the network entity 105-a.

In some cases, the UE 115-a may support estimating an EVM per antenna port of the network entity 105-a. For example, the UE 115-a may transmit, to the network entity 105-a (e.g., at establishment of a connection between the UE 115-a and the network entity 105-a), a capability report indicating that the UE 115-a is capable of such estimation. The UE 115-a may receive a signal 230, which may include each pilot signal 210 (e.g., including the signal 215 and each noise floor 220). The UE 115-a may transmit an EVM report 235 to the network entity 105-a indicating an estimated EVM for each antenna port of the network entity 105-a. For example, the UE 115-a may include, in the EVM report 235, an estimated distortion value associated with each antenna port of the network entity 105-a. In some examples, the UE 115-a may report the distortion values as decibel values, percentages, a relative difference from a most recent EVM report 235 (e.g., to reduce reporting overhead), a relative difference between antenna ports (e.g., a first EVM for a first port may signaled directly, a second EVM for a second port may be signaled as a difference from the first EVM, and so on), or any combination thereof. In some cases, the EVM report 235 may be a control message, such as a MAC control element (MAC-CE) or an RRC signal. Additionally, the UE 115-a may transmit the EVM report 235 periodically or may transmit the EVM report 235 aperiodically.

To estimate the EVM for each antenna port, the UE 115-a may differentiate between transmission noise and reception noise (e.g., to isolate the distortion of each pilot signal 210) using one or more techniques.

As an example, the UE 115-a may perform a maximal-ratio combining (MRC) procedure to determine the distortion values associated with the pilot signals 210. As part of the MRC procedure, the UE 115-a may add each pilot signal together, and may adjust a gain of each respective channel of the pilot signals 210 to be proportional to a root-mean squared (RMS) signal level and inversely proportional to a mean square noise level of the respective channel. In some examples, an output of the MRC procedure may represent an SNR equal to a sum of each SNR associated with the received pilot signals 210, which may indicate a diversity gain (e.g., a maximum possible diversity gain) of a quantity of antennas used for the MRC procedure. In some cases, a quantity of reception antennas used by the UE 115-a may support the UE 115-a identifying the EVM per antenna port of the network entity 105-a. For example, the UE 115-a may expect that adding a quantity of reception antennas to the MRC procedure will yield a gain value (e.g., a factor of 2 reception antennas should give a 3 dB gain), and may perform the MRC procedure using an increasing quantity of reception antennas. In some cases, the UE 115-a may identify that the transmitter EVM has been reached based on the UE 115-a not observing the expected gain after using additional reception antennas for the MRC procedure (e.g., assuming no interfering signals, which may be expected for sub-THz bands with narrow beams due to good spatial separation). Additionally, or alternatively, the UE 115-a may use multiple hypotheses for the used reception antennas for the MRC procedure, which may improve a reliability of the estimation (e.g., due to different reception antennas having different channel responses). For example, the UE 115-a may identify that the expected gain value is not met for an MRC hypothesis (e.g., an arrangement of antennas used in the MRC procedure), and may determine a post processing SNR (e.g., an SNR after the MRC procedure). In some cases, the UE 115-a may determine a distortion value according to the post processing SNR, which may be a negation of the post processing SNR. For example, the UE 115-a may report, in the EVM report 235, a distortion value corresponding to negated post processing SNR (e.g., post processing SNR*−1) for an MRC hypothesis that does not yield an expected gain.

As another example, the UE 115-a may identify a transmitter noise covariance matrix to support identifying the distortion of each pilot signal 210. In some cases, the UE 115-a may measure one or more noise values using each reception antenna, such as respective first noise values corresponding to a measurement of a wireless channel that is not carrying a pilot signal 210 (e.g., a noise of a channel in the absence of a signal) and respective second noise values corresponding to an estimated noise of each pilot signal 210 (e.g., a noise of the data signal). For example, the UE 115-a may take one or more measurements of a noise of the wireless channel and a noise of the data, and may relate the rate of change of each noise value to identify data distortion (e.g., while eliminating or mitigating an interference affecting the wireless channel). For example, the UE 115-a may receive, using an antenna port, a signal, y, including data of a respective pilot signal 210, x, that has been affected by a channel response of the wireless channel, H, to identify the first noise value, n (e.g., channel noise), and the second noise value, δx (e.g., signal noise), as reflected in Equation 1 below.

y=H(x+δx)+n (1)

In some cases, the UE 115-a may be aware of a variance of the channel noise

$$( {e}_{.} g . , {σ}_{n}^{2} = E \{ {nn}^{*} \}$$

may be obtainable). In such examples, the UE 115-a may obtain a channel noise covariance,

$${\hat{σ}}_{n}^{2} ,$$

according to the variance of the channel noise,

$${σ}_{n}^{2} ,$$

a variance of the data distortion,

$${σ}_{δ x}^{2} ,$$

and the channel response, H, as reflected in Equation 2 below.

$${\hat{σ}}_{n}^{2} = E \{ {\vert y - Hx \vert}^{2} \} = E \{ {\vert H δ x + n \vert}^{2} \} = H {σ}_{δ x}^{2} {H}^{*} + {σ}_{n}^{2} \qquad ( 2 )$$

The UE 115-a may then determine (e.g., isolate) a signal distortion covariance,

$${\hat{σ}}_{δ x}^{2} ,$$

for the antenna port according to the channel noise covariance, the variance of the channel noise, and a channel response for one or more pilot signal receptions using the antenna port. For example, for a quantity of NRx receptions by the antenna port, the UE 115-a may determine the signal distortion covariance for the antenna port according to an average of distortion associated with each of the NRx receptions, as reflected in Equation 3 below.

$${\hat{σ}}_{δ x}^{2} = \frac{1}{{N}_{R x}} {\sum }_{R {x}_{i} ∈ {N}_{R x}} \frac{( {\hat{σ}}_{n}^{2} ( R {x}_{i} ) - {σ}_{n}^{2} ( R {x}_{i} ) )}{{\vert H ( R {x}_{i} ) \vert}^{2}} \qquad ( 3 )$$

Such techniques may enable the UE 115-a to provide the network entity 105-a with an estimated EVM that is independent of interference associated with the wireless channel. For example, the UE 115-a may eliminate (or otherwise mitigate) the channel response, an interference of the channel (e.g., interference from other wireless channels), or both from the EVM estimation, which may increase an accuracy of the estimation. For example, the UE 115-a may be aware of an interference of the channel from a physical downlink shared channel (PDSCH) DMRS.

In some examples, the network entity 105-a may transmit one or more signals 240 (e.g., PDSCH transmissions) based on receiving the EVM report 235. In some cases, the network entity 105-a may use the reported EVM to configure one or more parameters of the one or more signals 240. For example, the network entity 105-a may determine an output power (e.g., to balance a link budget in light of EVM distortion), a waveform, a rank, a precoding configuration, a beamforming configuration, or any combination thereof of the one or more signals 240 according to the reported distortion values. Such modifications may improve a throughput of communicating the one or more signals 240.

The wireless communications system 202 may support the network entity 105-b (e.g., a receiving wireless device) configuring the UE 115-b (e.g., a transmitting wireless device) for transmitting one or more signals by estimating an EVM associated with each antenna port of the UE 115-b.

In some cases, the UE 115-b may transmit a message 250 to the network entity 105-b indicating one or more capabilities of the UE 115-b. For example, the UE 115-b may transmit, in the message 250, a capability of the UE 115-b to transmit a full bandwidth or partial bandwidth (e.g., according to a configuration by the network entity 105-b) pilot signal from each transmission antenna port of the UE 115-b. In some cases, if the EVM of the UE 115-b is non-linear with the bandwidth, the network entity 105-b may request the UE 115-b to transmit pilot signals per bandwidth size. Additionally, or alternatively, the message 250 may include a request for the network entity 105-b to perform EVM estimation. For example, the UE 115-b may identify a change in EVM from a last report (e.g., due to a change in temperature) and may transmit the message 250 requesting the network entity 105-b perform EVM estimation.

The UE 115-b may transmit one or more pilot signals 255 to the network entity 105-b to support the EVM estimation. In some cases, the network entity 105-b may configure the UE 115-b to transmit desired pilot signals (e.g., based on bandwidth) in the pilot signals 255. In some cases, the pilot signals 255 may be examples of the pilot signals 205 described with reference to FIG. 2A. In some cases, the network entity 105-b may perform EVM estimation for transmission antenna ports of the UE 115-b using techniques described with reference to FIG. 2A.

In some examples, the network entity 105-b may transmit a configuration 260 (e.g., indicating one or more physical layer parameters) after performing EVM estimation. For example, the network entity 105-b may transmit, in the configuration 260, physical layer modifications for subsequent uplink transmissions, such as precoding information, a quantity of spatial layers, or both, among other examples. The UE 115-b may then communicate one or more uplink signals 265 according to the configuration 260 (e.g., adjusting one or more physical layer parameters indicated by the configuration 260). Such techniques may improve a throughput of communications between the network entity 105-b and the UE 115-b.

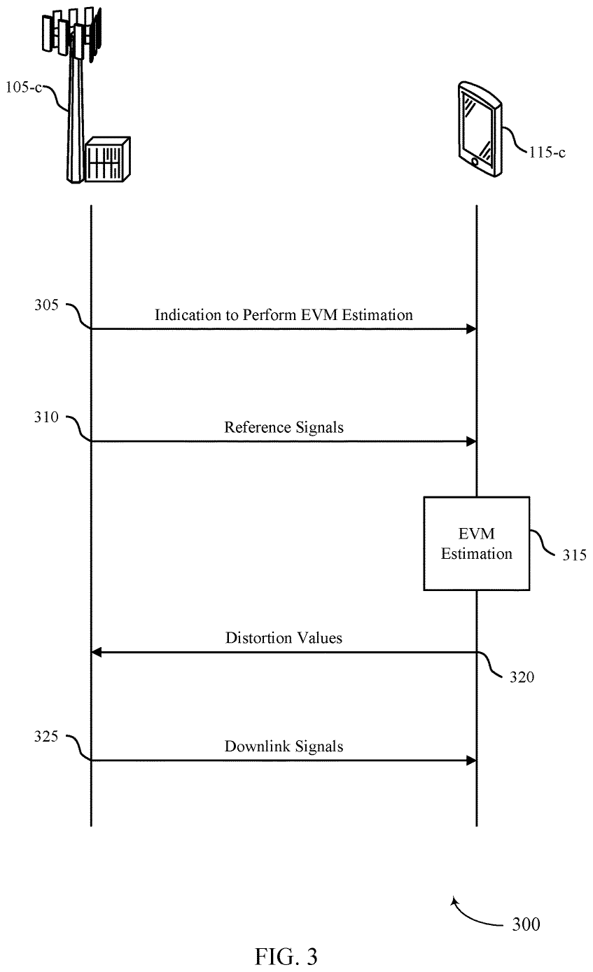

FIG. 3 shows an example of a process flow 300 that supports EVM estimation and reporting in accordance with one or more aspects of the present disclosure. The process flow 300 may be implemented by one or more aspects of the wireless communications systems 100, 201, and 202. For example, the process flow 300 may include a network entity 105-c and a UE 115-c, which may be examples of corresponding devices described with reference to FIGS. 1, 2A, and 2B. The process flow 300 may support EVM estimation and reporting in a downlink scenario. For example, the network entity 105-c (e.g., a transmitting device) may receive an EVM report from the UE 115-c (e.g., a receiving device) to improve a throughput of downlink communications. Alternative examples of the following may be implemented, where some processes are performed in a different order than described or are not performed. In some cases, processes may include additional features not mentioned below, or further processes may be added.

At 305, the network entity 105-c may transmit, to the UE 115-c, an indication that the UE 115-c is to perform an EVM estimation procedure. In some cases, the network entity 105-c may transmit the indication after determining to initiate the EVM estimation procedure. For example, the network entity 105-c may determine to initiate the EVM estimation procedure based on a change in EVM associated with the network entity 105-b (e.g., due to temperature, data precoding information, or a rank of data, among other examples), a change in one or more channel conditions associated with a wireless channel between the network entity 105-c and the UE 115-c (e.g., if a precoding method or beamforming information with rank optimization is limited by the EVM), a noise limitation associated with the UE 115-c (e.g., communication with the UE 115-c is limited by the noise present on the transmitted signal and the EVM impacts the overall SINR), or any combination thereof.

At 310, the network entity 105-c may transmit, to the UE 115-c, one or more reference signals via one or more antenna ports of the network entity 105-c. The UE 115-c may receive the one or more reference signals using one or more antenna ports of the UE 115-c, where each reference signal of the one or more reference signals may correspond to a respective antenna port of the one or more antenna ports. In some examples, each antenna port of the one or more antenna ports may be configured according to a FDD pattern, a TDD pattern, or both. In some cases, the reference signals may be examples of pilot signals configured by the network entity 105-c, which may be communicated via one or more frequency resources dedicated to EVM estimation. In some examples, each reference signal of the one or more reference signals may include a CSI-RS or a DMRS. Additionally, or alternatively, each reference signal of the one or more reference signals may include a TB that is encoded onto a shared data channel. In some cases, the UE 115-c may receive the one or more reference signals via a bandwidth associated with the wireless channel, where each reference signal of the one or more references signals may span across the bandwidth (e.g., the full bandwidth). In some other cases, the UE 115-c may receive each reference signal of the one or more reference signals via a respective BWP of the bandwidth (e.g., to support the UE 115-c estimating EVM for different parts of the bandwidth).

At 315, the UE 115-c may estimate an EVM associated with each antenna port of the network entity 105-c. In some cases, the UE 115-c may identify one or more distortion values corresponding to a measured distortion associated with each respective reference signal of the one or more reference signals. The one or more distortion values may be independent of other sources of distortion (e.g., an interference on the channel, a channel response, a noise on the channel, or the like) associated with the wireless channel between the UE 115-c and the network entity 105-c.

The UE 115-c may identify the one or more distortion values using one or more techniques. As a first example, the UE 115-c may measure a respective first noise value using each antenna port of the one or more antenna ports, where each of the respective first noise values may correspond to a measurement of the wireless channel that is not carrying the one or more reference signals (e.g., a channel noise measurement) and may measure a respective second noise value using each antenna port of the one or more antenna ports, where each of the respective second noise values may correspond to an estimated noise associated with each respective reference signal of the one or more reference signals (e.g., a data noise measurement). The UE 115-c may determine a respective distortion value of the one or more distortion values on a function of the respective first noise value and the respective second noise value. For example, the UE 115-c may obtain, for the one or more antenna ports, respective first noise covariances based on the respective first noise values and respective second noise covariances based on the respective second noise values and may obtain the one or more distortion values based on the respective first noise covariances, the respective second noise covariances, and respective estimations of respective channels between the network entity and the one or more antenna ports (See, e.g., Equations 2 and 3). In some cases, the UE 115-c may estimate a channel response of the wireless channel using a first antenna port of the one or more antenna ports based on decoding data associated with a first reference signal of the one or more reference signals (e.g., decoding data to identify a channel response, which may support isolating distortion by eliminating or mitigating the effect of the channel response on the data distortion), where the first antenna port may correspond to the first reference signal and a first distortion value of the one or more distortion values associated with the first reference signal may be based on the estimated channel response.

As a second example, the UE 115-c may determine the one or more distortion values according to an MRC procedure, where the MRC procedure may be based on a quantity of the one or more antenna ports of the UE 115-c. For example, the UE 115-c may increase a factor of the MRC (e.g., a factor of 2) until an expected gain is not observed (e.g., 3 dB gain), which may indicate that the transmitter EVM has been reached.

At 320, the UE 115-c may transmit, to the network entity 105-c, a message including the one or more distortion values (e.g., an EVM report). In some cases, the message may include a MAC-CE or an RRC, and may be a periodic message or an aperiodic message. In some cases, each distortion value of the one or more distortion values may be a decibel value, a percentage, a difference between the measured distortion of the respective reference signal and a prior distortion measurement using the respective antenna port, a difference between the measured distortion of the respective reference signal and a second measured distortion of a second reference signal of the one or more reference signals, or any combination thereof.

At 325, the network entity 105-c may transmit, to the UE 115-c, one or more signals (e.g., downlink signals) based on transmitting the message. In some cases, the network entity 105-c may modify the one or more signals based on the reported EVM from the UE 115-c (e.g., to improve throughput). For example, the network entity 105-c may determine an output power, a waveform, a rank, a precoding configuration, a beamforming configuration, or any combination thereof associated with the one or more signals based on the one or more distortion values.

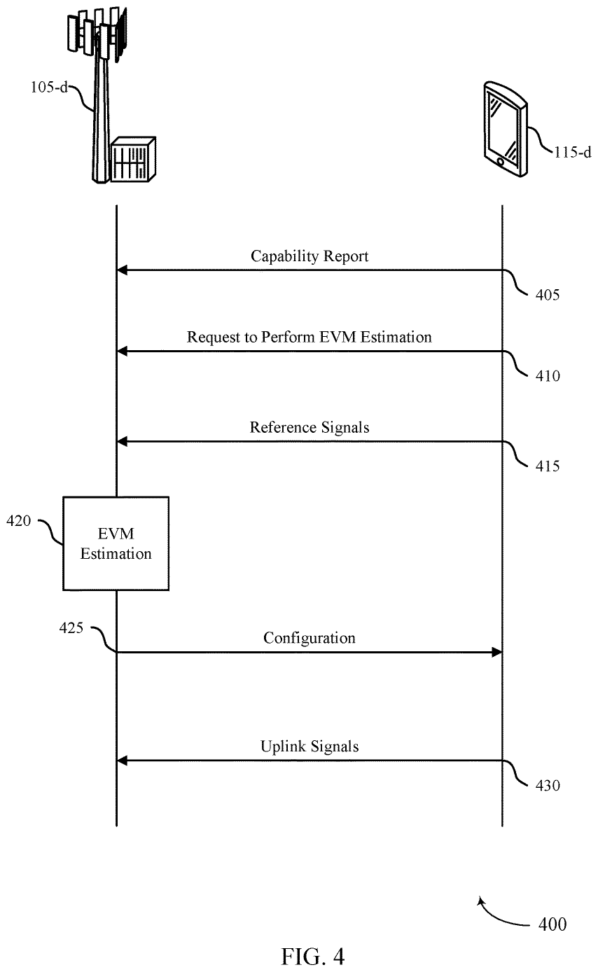

FIG. 4 shows an example of a process flow 400 that supports EVM estimation and reporting in accordance with one or more aspects of the present disclosure. The process flow 400 may be implemented by one or more aspects of the wireless communications systems 100, 201, and 202. For example, the process flow 400 may include a network entity 105-d and a UE 115-d, which may be examples of corresponding devices described with reference to FIGS. 1, 2A, and 2B. The process flow 400 may support EVM estimation and reporting in an uplink scenario. For example, the network entity 105-d (e.g., a receiving device) may transmit an EVM report to the UE 115-c (e.g., a transmitting device) to improve a throughput of uplink communications. Alternative examples of the following may be implemented, where some processes are performed in a different order than described or are not performed. In some cases, processes may include additional features not mentioned below, or further processes may be added.

At 405, the UE 115-d may transmit, to the network entity 105-d a capability report. In some cases, the capability report may indicate a capability of the UE 115-d to transmit one or more reference signals via one or more BWPs of a bandwidth (e.g., a full bandwidth or a partial bandwidth according to a configuration by the network entity 105-d) associated with a wireless channel between the network entity 105-d and the UE 115-d.

At 410, the UE 115-d may transmit, to the network entity 105-d, a request to perform an EVM estimation for one or more antenna ports of the UE 115-d. In some cases, the UE 115-d may transmit the request based on identifying a modification of the EVM since a last report (e.g., due to a change in temperature).

At 415, the UE 115-d may transmit, to the network entity 105-d, one or more reference signals to support the EVM estimation. In some cases, the network entity 105-d may receive the one or more reference signals via one or more antenna ports of the network entity 105-d, and each reference signal of the one or more reference signals may correspond to a respective antenna port of the one or more antenna ports. The one or more reference signals may include dedicated pilot signals, CSI-RSs, DMRSs, a TB encoded onto a shared data channel, or any combination thereof.

At 420, the network entity 105-d may estimate an EVM associated with each antenna port of the UE 115-d. The network entity 105-d may estimate the EVM using one or more techniques, such as estimating a transmission noise covariance matrix or performing an MRC procedure (See, e.g., FIG. 2A). In some cases, the network entity 105-d may identify one or more distortion values corresponding to measured distortion associated with a respective reference signal of the one or more reference signals. In some cases, the one or more distortion values may be independent of other distortion associated with the wireless channel. For example, the network entity may isolate a distortion of the data from an interference, a noise, a channel response, or the like associated with the wireless channel.

At 425, the network entity 105-d may transmit, to the UE 115-d, a configuration based on the one or more distortion values. For example, the configuration may indicate one or more physical layer parameters for transmitting one or more signals. the one or more physical layer parameters may include a precoding configuration, a quantity of spatial layers, or both, among other examples.

At 430, the UE 115-d may transmit, to the network entity 105-d, one or more signals (e.g., uplink signals) according to the configuration. By configuring the signals according to the estimated EVM of the antenna ports of the UE 115-d, a throughput of the communications may be improved.

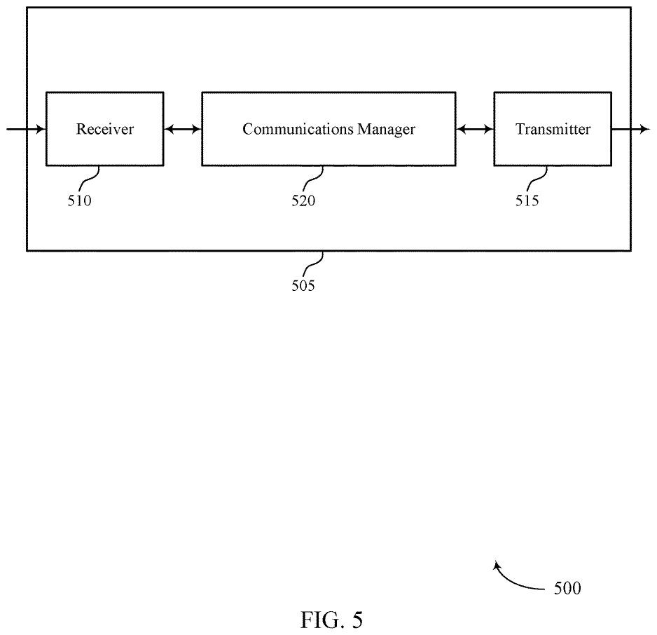

FIG. 5 shows a block diagram 500 of a device 505 that supports EVM estimation and reporting in accordance with one or more aspects of the present disclosure. The device 505 may be an example of aspects of a UE 115 as described herein. The device 505 may include a receiver 510, a transmitter 515, and a communications manager 520. The device 505, or one or more components of the device 505 (e.g., the receiver 510, the transmitter 515, and the communications manager 520), may include at least one processor, which may be coupled with at least one memory, to support the described techniques. Each of these components may be in communication with one another (e.g., via one or more buses).

The receiver 510 may provide a means for receiving information such as packets, user data, control information, or any combination thereof associated with various information channels (e.g., control channels, data channels, information channels related to EVM estimation and reporting). Information may be passed on to other components of the device 505. The receiver 510 may utilize a single antenna or a set of multiple antennas.

The transmitter 515 may provide a means for transmitting signals generated by other components of the device 505. For example, the transmitter 515 may transmit information such as packets, user data, control information, or any combination thereof associated with various information channels (e.g., control channels, data channels, information channels related to EVM estimation and reporting). In some examples, the transmitter 515 may be co-located with a receiver 510 in a transceiver module. The transmitter 515 may utilize a single antenna or a set of multiple antennas.

The communications manager 520, the receiver 510, the transmitter 515, or various combinations thereof or various components thereof may be examples of means for performing various aspects of EVM estimation and reporting as described herein. For example, the communications manager 520, the receiver 510, the transmitter 515, or various combinations or components thereof may be capable of performing one or more of the functions described herein.

In some examples, the communications manager 520, the receiver 510, the transmitter 515, or various combinations or components thereof may be implemented in hardware (e.g., in communications management circuitry). The hardware may include at least one of a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by executing, by the at least one processor, instructions stored in the at least one memory).

Additionally, or alternatively, the communications manager 520, the receiver 510, the transmitter 515, or various combinations or components thereof may be implemented in code (e.g., as communications management software or firmware) executed by at least one processor. If implemented in code executed by at least one processor, the functions of the communications manager 520, the receiver 510, the transmitter 515, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 520 may be configured to perform various operations (e.g., receiving, obtaining, monitoring, outputting, transmitting) using or otherwise in cooperation with the receiver 510, the transmitter 515, or both. For example, the communications manager 520 may receive information from the receiver 510, send information to the transmitter 515, or be integrated in combination with the receiver 510, the transmitter 515, or both to obtain information, output information, or perform various other operations as described herein.

The communications manager 520 may support wireless communications at a UE in accordance with examples as disclosed herein. For example, the communications manager 520 is capable of, configured to, or operable to support a means for receiving, from a network entity, one or more reference signals via one or more antenna ports of the UE, each reference signal of the one or more reference signals corresponding to a respective antenna port of the one or more antenna ports. The communications manager 520 is capable of, configured to, or operable to support a means for transmitting, to the network entity, a message including one or more distortion values, each distortion value of the one or more distortion values corresponding to measured distortion associated with a respective reference signal of the one or more reference signals, where the one or more distortion values are independent of an interference associated with a wireless channel between the UE and the network entity.

By including or configuring the communications manager 520 in accordance with examples as described herein, the device 505 (e.g., at least one processor controlling or otherwise coupled with the receiver 510, the transmitter 515, the communications manager 520, or a combination thereof) may support techniques for improved data throughput by estimating and reporting EVM associated with a transmitting device.

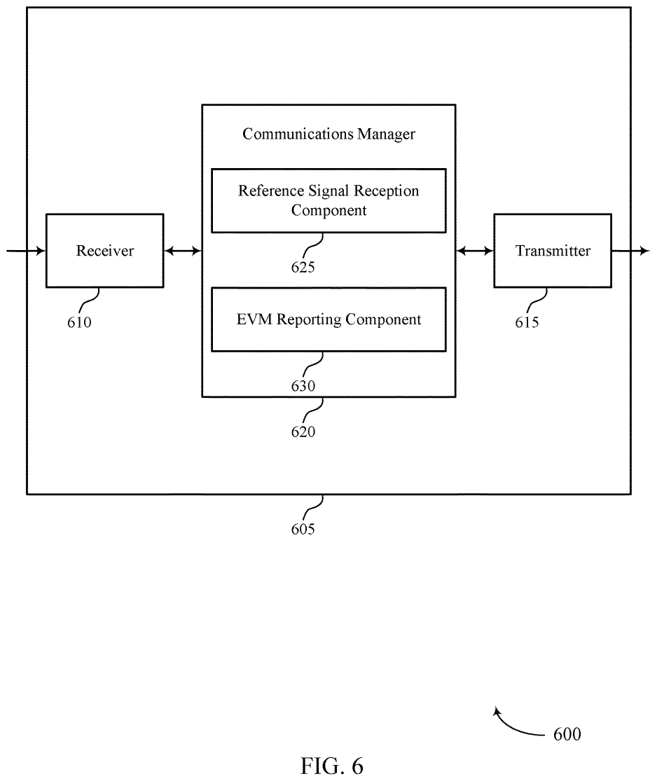

FIG. 6 shows a block diagram 600 of a device 605 that supports EVM estimation and reporting in accordance with one or more aspects of the present disclosure. The device 605 may be an example of aspects of a device 505 or a UE 115 as described herein. The device 605 may include a receiver 610, a transmitter 615, and a communications manager 620. The device 605, or one or more components of the device 605 (e.g., the receiver 610, the transmitter 615, and the communications manager 620), may also include at least one processor, which may be coupled with at least one memory, to support the described techniques. Each of these components may be in communication with one another (e.g., via one or more buses).

The receiver 610 may provide a means for receiving information such as packets, user data, control information, or any combination thereof associated with various information channels (e.g., control channels, data channels, information channels related to EVM estimation and reporting). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to EVM estimation and reporting). In some examples, the transmitter 615 may be co-located with a receiver 610 in a transceiver module. The transmitter 615 may utilize a single antenna or a set of multiple antennas.

The device 605, or various components thereof, may be an example of means for performing various aspects of EVM estimation and reporting as described herein. For example, the communications manager 620 may include a reference signal reception component 625 a EVM reporting component 630, or any combination thereof. The communications manager 620 may be an example of aspects of a communications manager 520 as described herein. In some examples, the communications manager 620, or various components thereof, may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE in accordance with examples as disclosed herein. The reference signal reception component 625 is capable of, configured to, or operable to support a means for receiving, from a network entity, one or more reference signals via one or more antenna ports of the UE, each reference signal of the one or more reference signals corresponding to a respective antenna port of the one or more antenna ports. The EVM reporting component 630 is capable of, configured to, or operable to support a means for transmitting, to the network entity, a message including one or more distortion values, each distortion value of the one or more distortion values corresponding to measured distortion associated with a respective reference signal of the one or more reference signals, where the one or more distortion values are independent of an interference associated with a wireless channel between the UE and the network entity.

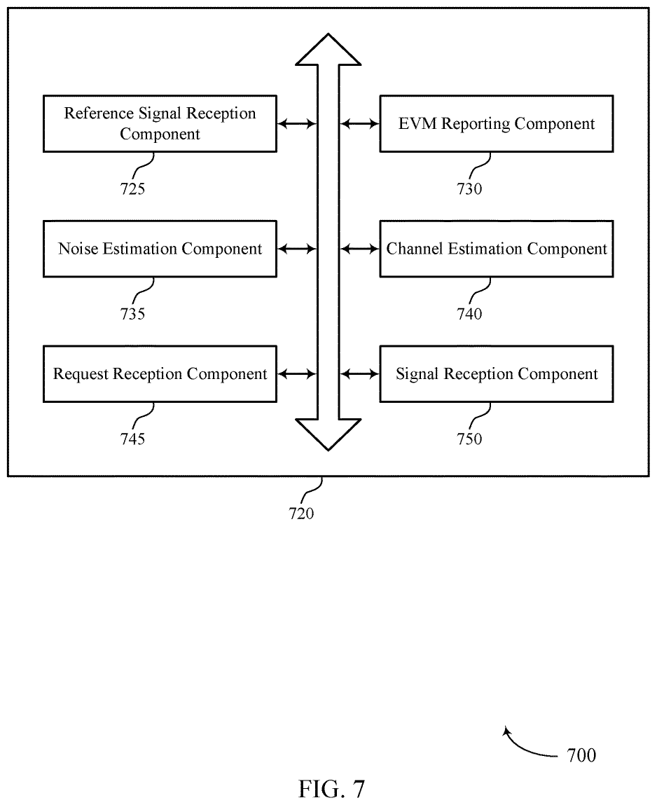

FIG. 7 shows a block diagram 700 of a communications manager 720 that supports EVM estimation and reporting in accordance with one or more aspects of the present disclosure. The communications manager 720 may be an example of aspects of a communications manager 520, a communications manager 620, or both, as described herein. The communications manager 720, or various components thereof, may be an example of means for performing various aspects of EVM estimation and reporting as described herein. For example, the communications manager 720 may include a reference signal reception component 725, a EVM reporting component 730, a noise estimation component 735, a channel estimation component 740, a request reception component 745, a signal reception component 750, or any combination thereof. Each of these components, or components of subcomponents thereof (e.g., one or more processors, one or more memories), may communicate, directly or indirectly, with one another (e.g., via one or more buses).

The communications manager 720 may support wireless communications at a UE in accordance with examples as disclosed herein. The reference signal reception component 725 is capable of, configured to, or operable to support a means for receiving, from a network entity, one or more reference signals via one or more antenna ports of the UE, each reference signal of the one or more reference signals corresponding to a respective antenna port of the one or more antenna ports. The EVM reporting component 730 is capable of, configured to, or operable to support a means for transmitting, to the network entity, a message including one or more distortion values, each distortion value of the one or more distortion values corresponding to measured distortion associated with a respective reference signal of the one or more reference signals, where the one or more distortion values are independent of an interference associated with a wireless channel between the UE and the network entity.

In some examples, the noise estimation component 735 is capable of, configured to, or operable to support a means for measuring a respective first noise value using each antenna port of the one or more antenna ports, where each of the respective first noise values corresponds to a measurement of the wireless channel that is not carrying the one or more reference signals. In some examples, the noise estimation component 735 is capable of, configured to, or operable to support a means for measuring a respective second noise value using each antenna port of the one or more antenna ports, where each of the respective second noise values corresponds to an estimated noise associated with each respective reference signal of the one or more reference signals, and where a respective distortion value of the one or more distortion values is determined based on a function of the respective first noise value and the respective second noise value.

In some examples, the noise estimation component 735 is capable of, configured to, or operable to support a means for obtaining, for the one or more antenna ports, respective first noise covariances based on the respective first noise values and respective second noise covariances based on the respective second noise values. In some examples, the noise estimation component 735 is capable of, configured to, or operable to support a means for obtaining the one or more distortion values based on the respective first noise covariances, the respective second noise covariances, and respective estimations of respective channels between the network entity and the one or more antenna ports.

In some examples, the one or more distortion values are determined according to a MRC procedure. In some examples, the MRC procedure is based on a quantity of the one or more antenna ports of the UE.

In some examples, the channel estimation component 740 is capable of, configured to, or operable to support a means for estimating a channel response of the wireless channel using a first antenna port of the one or more antenna ports based on decoding data associated with a first reference signal of the one or more reference signals, the first antenna port corresponding to the first reference signal, where a first distortion value of the one or more distortion values associated with the first reference signal is based on the estimated channel response.

In some examples, the request reception component 745 is capable of, configured to, or operable to support a means for receiving an indication that the UE is to perform an EVM estimation procedure, where receiving the one or more reference signals is based on receiving the indication.

In some examples, receiving the indication is based on a change in an EVM associated with the network entity, a change in one or more channel conditions associated with the wireless channel, a noise limitation associated with the UE, or a combination thereof.

In some examples, each reference signal of the one or more reference signals includes a CSI-RS or a DMRS.

In some examples, each reference signal of the one or more reference signals includes a transport block that is encoded onto a shared data channel.

In some examples, to support receiving the one or more reference signals, the reference signal reception component 725 is capable of, configured to, or operable to support a means for receiving the one or more reference signals via one or more frequency resources dedicated to performing EVM estimation.

In some examples, to support receiving the one or more reference signals, the reference signal reception component 725 is capable of, configured to, or operable to support a means for receiving the one or more reference signals via a bandwidth associated with the wireless channel, each reference signal of the one or more reference signals spanning across the bandwidth. In some examples, to support receiving the one or more reference signals, the reference signal reception component 725 is capable of, configured to, or operable to support a means for receiving each reference signal of the one or more reference signals via a respective bandwidth part of the bandwidth.

In some examples, each antenna port of the one or more antenna ports is configured according to a FDD pattern, a TDD pattern, or both.

In some examples, the message includes a MAC-CE or a RRC signal. In some examples, the message is a periodic message or an aperiodic message.

In some examples, each distortion value of the one or more distortion values includes a decibel value, a percentage, a difference between the measured distortion of the respective reference signal and a prior distortion measurement using the respective antenna port, a difference between the measured distortion of the respective reference signal and a second measured distortion of a second reference signal of the one or more reference signals, or a combination thereof.

In some examples, the signal reception component 750 is capable of, configured to, or operable to support a means for receiving one or more signals from the network entity based on transmitting the message, where an output power, a waveform, a rank, a precoding configuration, a beamforming configuration, or any combination thereof associated with the one or more signals is based on the one or more distortion values.

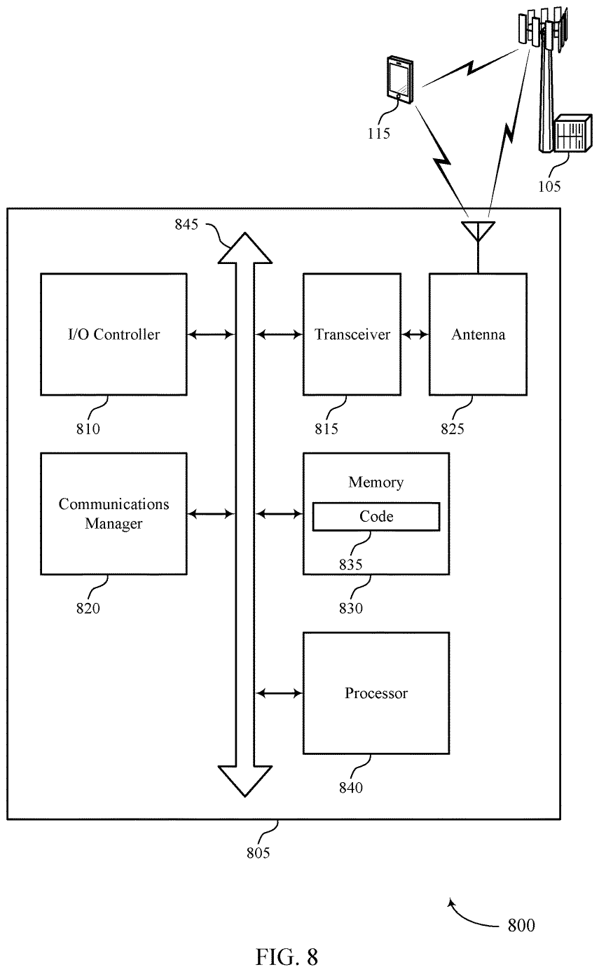

FIG. 8 shows a diagram of a system 800 including a device 805 that supports EVM estimation and reporting in accordance with one or more aspects of the present disclosure. The device 805 may be an example of or include the components of a device 505, a device 605, or a UE 115 as described herein. The device 805 may communicate (e.g., wirelessly) with one or more network entities 105, one or more UEs 115, or any combination thereof. The device 805 may include components for bi-directional voice and data communications including components for transmitting and receiving communications, such as a communications manager 820, an input/output (I/O) controller 810, a transceiver 815, an antenna 825, a memory 830, code 835, and a processor 840. These components may be in electronic communication or otherwise coupled (e.g., operatively, communicatively, functionally, electronically, electrically) via one or more buses (e.g., a bus 845).

The I/O controller 810 may manage input and output signals for the device 805. The I/O controller 810 may also manage peripherals not integrated into the device 805. In some cases, the I/O controller 810 may represent a physical connection or port to an external peripheral. In some cases, the I/O controller 810 may utilize an operating system such as iOS®, ANDROID®, MS-DOS®, MS-WINDOWS®, OS/2®, UNIX®, LINUX®, or another known operating system. Additionally, or alternatively, the I/O controller 810 may represent or interact with a modem, a keyboard, a mouse, a touchscreen, or a similar device. In some cases, the I/O controller 810 may be implemented as part of a processor, such as the processor 840. In some cases, a user may interact with the device 805 via the I/O controller 810 or via hardware components controlled by the I/O controller 810.

In some cases, the device 805 may include a single antenna 825. However, in some other cases, the device 805 may have more than one antenna 825, which may be capable of concurrently transmitting or receiving multiple wireless transmissions. The transceiver 815 may communicate bi-directionally, via the one or more antennas 825, wired, or wireless links as described herein. For example, the transceiver 815 may represent a wireless transceiver and may communicate bi-directionally with another wireless transceiver. The transceiver 815 may also include a modem to modulate the packets, to provide the modulated packets to one or more antennas 825 for transmission, and to demodulate packets received from the one or more antennas 825. The transceiver 815, or the transceiver 815 and one or more antennas 825, may be an example of a transmitter 515, a transmitter 615, a receiver 510, a receiver 610, or any combination thereof or component thereof, as described herein.

The memory 830 may include random access memory (RAM) and read-only memory (ROM). The memory 830 may store computer-readable, computer-executable code 835 including instructions that, when executed by the processor 840, cause the device 805 to perform various functions described herein. The code 835 may be stored in a non-transitory computer-readable medium such as system memory or another type of memory. In some cases, the code 835 may not be directly executable by the processor 840 but may cause a computer (e.g., when compiled and executed) to perform functions described herein. In some cases, the memory 830 may contain, among other things, a basic I/O system (BIOS) which may control basic hardware or software operation such as the interaction with peripheral components or devices.

The processor 840 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 840 may be configured to operate a memory array using a memory controller. In some other cases, a memory controller may be integrated into the processor 840. The processor 840 may be configured to execute computer-readable instructions stored in a memory (e.g., the memory 830) to cause the device 805 to perform various functions (e.g., functions or tasks supporting EVM estimation and reporting). For example, the device 805 or a component of the device 805 may include a processor 840 and memory 830 coupled with or to the processor 840, the processor 840 and memory 830 configured to perform various functions described herein.

The communications manager 820 may support wireless communications at a UE in accordance with examples as disclosed herein. For example, the communications manager 820 is capable of, configured to, or operable to support a means for receiving, from a network entity, one or more reference signals via one or more antenna ports of the UE, each reference signal of the one or more reference signals corresponding to a respective antenna port of the one or more antenna ports. The communications manager 820 is capable of, configured to, or operable to support a means for transmitting, to the network entity, a message including one or more distortion values, each distortion value of the one or more distortion values corresponding to measured distortion associated with a respective reference signal of the one or more reference signals, where the one or more distortion values are independent of an interference associated with a wireless channel between the UE and the network entity.

By including or configuring the communications manager 820 in accordance with examples as described herein, the device 805 may support techniques for improved data throughput by estimating and reporting EVM associated with a transmitting device.

In some examples, the communications manager 820 may be configured to perform various operations (e.g., receiving, monitoring, transmitting) using or otherwise in cooperation with the transceiver 815, the one or more antennas 825, or any combination thereof. Although the communications manager 820 is illustrated as a separate component, in some examples, one or more functions described with reference to the communications manager 820 may be supported by or performed by the processor 840, the memory 830, the code 835, or any combination thereof. For example, the code 835 may include instructions executable by the processor 840 to cause the device 805 to perform various aspects of EVM estimation and reporting as described herein, or the processor 840 and the memory 830 may be otherwise configured to perform or support such operations.

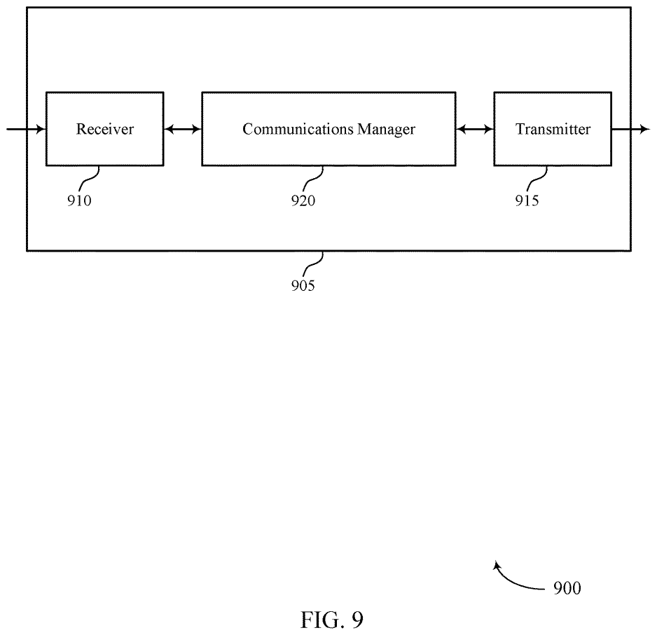

FIG. 9 shows a block diagram 900 of a device 905 that supports EVM estimation and reporting in accordance with one or more aspects of the present disclosure. The device 905 may be an example of aspects of a network entity 105 as described herein. The device 905 may include a receiver 910, a transmitter 915, and a communications manager 920. The device 905, or one or more components of the device 905 (e.g., the receiver 910, the transmitter 915, and the communications manager 920), may include at least one processor, which may be coupled with at least one memory, to support the described techniques. Each of these components may be in communication with one another (e.g., via one or more buses).

The receiver 910 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 905. In some examples, the receiver 910 may support obtaining information by receiving signals via one or more antennas. Additionally, or alternatively, the receiver 910 may support obtaining information by receiving signals via one or more wired (e.g., electrical, fiber optic) interfaces, wireless interfaces, or any combination thereof.

The transmitter 915 may provide a means for outputting (e.g., transmitting, providing, conveying, sending) information generated by other components of the device 905. For example, the transmitter 915 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 915 may support outputting information by transmitting signals via one or more antennas. Additionally, or alternatively, the transmitter 915 may support outputting information by transmitting signals via one or more wired (e.g., electrical, fiber optic) interfaces, wireless interfaces, or any combination thereof. In some examples, the transmitter 915 and the receiver 910 may be co-located in a transceiver, which may include or be coupled with a modem.

The communications manager 920, the receiver 910, the transmitter 915, or various combinations thereof or various components thereof may be examples of means for performing various aspects of EVM estimation and reporting as described herein. For example, the communications manager 920, the receiver 910, the transmitter 915, or various combinations or components thereof may be capable of performing one or more of the functions described herein.

In some examples, the communications manager 920, the receiver 910, the transmitter 915, or various combinations or components thereof may be implemented in hardware (e.g., in communications management circuitry). The hardware may include at least one of a processor, a DSP, a CPU, an ASIC, an FPGA or other programmable logic device, a microcontroller, discrete gate or transistor logic, discrete hardware components, or any combination thereof configured as or otherwise supporting, individually or collectively, a means for performing the functions described in the present disclosure. In some examples, at least one processor and at least one memory coupled with the at least one processor may be configured to perform one or more of the functions described herein (e.g., by executing, by the at least one processor, instructions stored in the at least one memory).

Additionally, or alternatively, the communications manager 920, the receiver 910, the transmitter 915, or various combinations or components thereof may be implemented in code (e.g., as communications management software or firmware) executed by at least one processor. If implemented in code executed by at least one processor, the functions of the communications manager 920, the receiver 910, the transmitter 915, or various combinations or components thereof may be performed by a general-purpose processor, a DSP, a CPU, an ASIC, an FPGA, a microcontroller, or any combination of these or other programmable logic devices (e.g., configured as or otherwise supporting, individually or collectively, a means for performing the functions described in the present disclosure).

In some examples, the communications manager 920 may be configured to perform various operations (e.g., receiving, obtaining, monitoring, outputting, transmitting) using or otherwise in cooperation with the receiver 910, the transmitter 915, or both. For example, the communications manager 920 may receive information from the receiver 910, send information to the transmitter 915, or be integrated in combination with the receiver 910, the transmitter 915, or both to obtain information, output information, or perform various other operations as described herein.

The communications manager 920 may support wireless communications at a network entity in accordance with examples as disclosed herein. For example, the communications manager 920 is capable of, configured to, or operable to support a means for receiving, from a UE, one or more reference signals via one or more antenna ports of the network entity, each reference signal of the one or more reference signals corresponding to a respective antenna port of the one or more antenna ports. The communications manager 920 is capable of, configured to, or operable to support a means for transmitting, to the UE, a configuration for transmitting one or more signals based on one or more distortion values, each distortion value of the one or more distortion values corresponding to measured distortion associated with a respective reference signal of the one or more reference signals, where the one or more distortion values are independent of an interference associated with a wireless channel between the UE and the network entity.

By including or configuring the communications manager 920 in accordance with examples as described herein, the device 905 (e.g., at least one processor controlling or otherwise coupled with the receiver 910, the transmitter 915, the communications manager 920, or a combination thereof) may support techniques for improved data throughput by estimating and reporting EVM associated with a transmitting device.

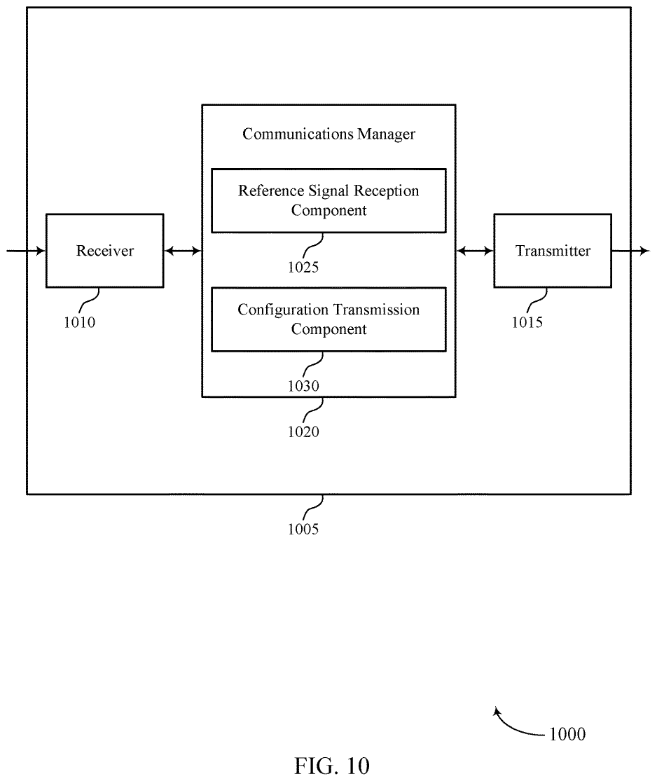

FIG. 10 shows a block diagram 1000 of a device 1005 that supports EVM estimation and reporting in accordance with one or more aspects of the present disclosure. The device 1005 may be an example of aspects of a device 905 or a network entity 105 as described herein. The device 1005 may include a receiver 1010, a transmitter 1015, and a communications manager 1020. The device 1005, or one or more components of the device 1005 (e.g., the receiver 1010, the transmitter 1015, and the communications manager 1020), may also include at least one processor, which may be coupled with at least one memory, to support the described techniques. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The device 1005, or various components thereof, may be an example of means for performing various aspects of EVM estimation and reporting as described herein. For example, the communications manager 1020 may include a reference signal reception component 1025 a configuration transmission component 1030, or any combination thereof. The communications manager 1020 may be an example of aspects of a communications manager 920 as described herein. In some examples, the communications manager 1020, or various components thereof, may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity in accordance with examples as disclosed herein. The reference signal reception component 1025 is capable of, configured to, or operable to support a means for receiving, from a UE, one or more reference signals via one or more antenna ports of the network entity, each reference signal of the one or more reference signals corresponding to a respective antenna port of the one or more antenna ports. The configuration transmission component 1030 is capable of, configured to, or operable to support a means for transmitting, to the UE, a configuration for transmitting one or more signals based on one or more distortion values, each distortion value of the one or more distortion values corresponding to measured distortion associated with a respective reference signal of the one or more reference signals, where the one or more distortion values are independent of an interference associated with a wireless channel between the UE and the network entity.

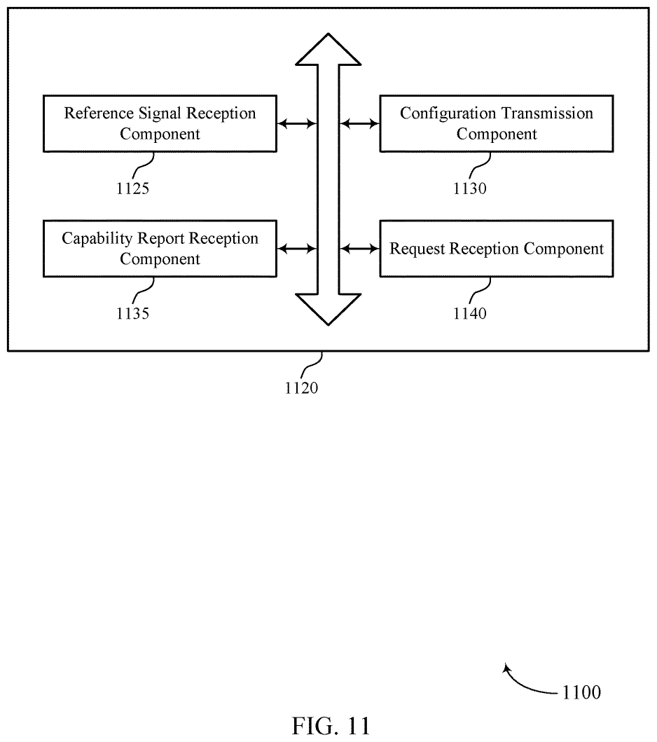

FIG. 11 shows a block diagram 1100 of a communications manager 1120 that supports EVM estimation and reporting in accordance with one or more aspects of the present disclosure. The communications manager 1120 may be an example of aspects of a communications manager 920, a communications manager 1020, or both, as described herein. The communications manager 1120, or various components thereof, may be an example of means for performing various aspects of EVM estimation and reporting as described herein. For example, the communications manager 1120 may include a reference signal reception component 1125, a configuration transmission component 1130, a capability report reception component 1135, a request reception component 1140, or any combination thereof. Each of these components, or components of subcomponents thereof (e.g., one or more processors, one or more memories), may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1120 may support wireless communications at a network entity in accordance with examples as disclosed herein. The reference signal reception component 1125 is capable of, configured to, or operable to support a means for receiving, from a UE, one or more reference signals via one or more antenna ports of the network entity, each reference signal of the one or more reference signals corresponding to a respective antenna port of the one or more antenna ports. The configuration transmission component 1130 is capable of, configured to, or operable to support a means for transmitting, to the UE, a configuration for transmitting one or more signals based on one or more distortion values, each distortion value of the one or more distortion values corresponding to measured distortion associated with a respective reference signal of the one or more reference signals, where the one or more distortion values are independent of an interference associated with a wireless channel between the UE and the network entity.

In some examples, the capability report reception component 1135 is capable of, configured to, or operable to support a means for receiving, from the UE, a capability report indicating a capability of the UE to transmit the one or more reference signals via one or more bandwidth parts of a bandwidth associated with the wireless channel.

In some examples, the configuration indicates one or more physical layer parameters for transmitting the one or more signals, the one or more physical layer parameters including a precoding configuration, a quantity of spatial layers, or both.

In some examples, the request reception component 1140 is capable of, configured to, or operable to support a means for receiving, from the UE, a request to perform an EVM estimation procedure, where receiving the one or more reference signals is based on receiving the request.

In some examples, each reference signal of the one or more reference signals includes a CSI-RS or a DMRS.

In some examples, each reference signal of the one or more reference signals includes a transport block that is encoded onto a shared data channel.

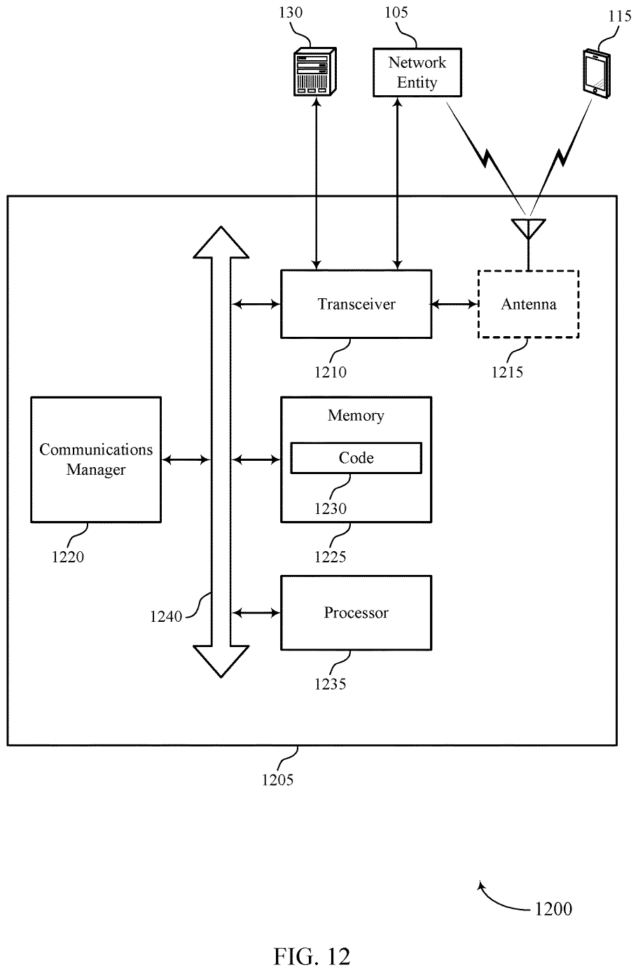

FIG. 12 shows a diagram of a system 1200 including a device 1205 that supports EVM estimation and reporting in accordance with one or more aspects of the present disclosure. The device 1205 may be an example of or include the components of a device 905, a device 1005, or a network entity 105 as described herein. The device 1205 may communicate with one or more network entities 105, one or more UEs 115, or any combination thereof, which may include communications over one or more wired interfaces, over one or more wireless interfaces, or any combination thereof. The device 1205 may include components that support outputting and obtaining communications, such as a communications manager 1220, a transceiver 1210, an antenna 1215, a memory 1225, code 1230, and a processor 1235. These components may be in electronic communication or otherwise coupled (e.g., operatively, communicatively, functionally, electronically, electrically) via one or more buses (e.g., a bus 1240).

The transceiver 1210 may support bi-directional communications via wired links, wireless links, or both as described herein. In some examples, the transceiver 1210 may include a wired transceiver and may communicate bi-directionally with another wired transceiver. Additionally, or alternatively, in some examples, the transceiver 1210 may include a wireless transceiver and may communicate bi-directionally with another wireless transceiver. In some examples, the device 1205 may include one or more antennas 1215, which may be capable of transmitting or receiving wireless transmissions (e.g., concurrently). The transceiver 1210 may also include a modem to modulate signals, to provide the modulated signals for transmission (e.g., by one or more antennas 1215, by a wired transmitter), to receive modulated signals (e.g., from one or more antennas 1215, from a wired receiver), and to demodulate signals. In some implementations, the transceiver 1210 may include one or more interfaces, such as one or more interfaces coupled with the one or more antennas 1215 that are configured to support various receiving or obtaining operations, or one or more interfaces coupled with the one or more antennas 1215 that are configured to support various transmitting or outputting operations, or a combination thereof. In some implementations, the transceiver 1210 may include or be configured for coupling with one or more processors or memory components that are operable to perform or support operations based on received or obtained information or signals, or to generate information or other signals for transmission or other outputting, or any combination thereof. In some implementations, the transceiver 1210, or the transceiver 1210 and the one or more antennas 1215, or the transceiver 1210 and the one or more antennas 1215 and one or more processors or memory components (for example, the processor 1235, or the memory 1225, or both), may be included in a chip or chip assembly that is installed in the device 1205. In some examples, the transceiver may be operable to support communications via one or more communications links (e.g., a communication link 125, a backhaul communication link 120, a midhaul communication link 162, a fronthaul communication link 168).

The memory 1225 may include RAM and ROM. The memory 1225 may store computer-readable, computer-executable code 1230 including instructions that, when executed by the processor 1235, cause the device 1205 to perform various functions described herein. The code 1230 may be stored in a non-transitory computer-readable medium such as system memory or another type of memory. In some cases, the code 1230 may not be directly executable by the processor 1235 but may cause a computer (e.g., when compiled and executed) to perform functions described herein. In some cases, the memory 1225 may contain, among other things, a BIOS which may control basic hardware or software operation such as the interaction with peripheral components or devices.

The processor 1235 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1235 may be configured to operate a memory array using a memory controller. In some other cases, a memory controller may be integrated into the processor 1235. The processor 1235 may be configured to execute computer-readable instructions stored in a memory (e.g., the memory 1225) to cause the device 1205 to perform various functions (e.g., functions or tasks supporting EVM estimation and reporting). For example, the device 1205 or a component of the device 1205 may include a processor 1235 and memory 1225 coupled with the processor 1235, the processor 1235 and memory 1225 configured to perform various functions described herein. The processor 1235 may be an example of a cloud-computing platform (e.g., one or more physical nodes and supporting software such as operating systems, virtual machines, or container instances) that may host the functions (e.g., by executing code 1230) to perform the functions of the device 1205. The processor 1235 may be any one or more suitable processors capable of executing scripts or instructions of one or more software programs stored in the device 1205 (such as within the memory 1225). In some implementations, the processor 1235 may be a component of a processing system. A processing system may generally refer to a system or series of machines or components that receives inputs and processes the inputs to produce a set of outputs (which may be passed to other systems or components of, for example, the device 1205). For example, a processing system of the device 1205 may refer to a system including the various other components or subcomponents of the device 1205, such as the processor 1235, or the transceiver 1210, or the communications manager 1220, or other components or combinations of components of the device 1205. The processing system of the device 1205 may interface with other components of the device 1205, and may process information received from other components (such as inputs or signals) or output information to other components. For example, a chip or modem of the device 1205 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1205 may transmit information output from the chip or modem. Additionally, or alternatively, in some implementations, the one or more interfaces may refer to an interface between the processing system of the chip or modem and a receiver, such that the device 1205 may obtain information or signal inputs, and the information may be passed to the processing system. A person having ordinary skill in the art will readily recognize that a first interface also may obtain information or signal inputs, and a second interface also may output information or signal outputs.

In some examples, a bus 1240 may support communications of (e.g., within) a protocol layer of a protocol stack. In some examples, a bus 1240 may support communications associated with a logical channel of a protocol stack (e.g., between protocol layers of a protocol stack), which may include communications performed within a component of the device 1205, or between different components of the device 1205 that may be co-located or located in different locations (e.g., where the device 1205 may refer to a system in which one or more of the communications manager 1220, the transceiver 1210, the memory 1225, the code 1230, and the processor 1235 may be located in one of the different components or divided between different components).

In some examples, the communications manager 1220 may manage aspects of communications with a core network 130 (e.g., via one or more wired or wireless backhaul links). For example, the communications manager 1220 may manage the transfer of data communications for client devices, such as one or more UEs 115. In some examples, the communications manager 1220 may manage communications with other network entities 105, and may include a controller or scheduler for controlling communications with UEs 115 in cooperation with other network entities 105. In some examples, the communications manager 1220 may support an X2 interface within an LTE/LTE-A wireless communications network technology to provide communication between network entities 105.

The communications manager 1220 may support wireless communications at a network entity in accordance with examples as disclosed herein. For example, the communications manager 1220 is capable of, configured to, or operable to support a means for receiving, from a UE, one or more reference signals via one or more antenna ports of the network entity, each reference signal of the one or more reference signals corresponding to a respective antenna port of the one or more antenna ports. The communications manager 1220 is capable of, configured to, or operable to support a means for transmitting, to the UE, a configuration for transmitting one or more signals based on one or more distortion values, each distortion value of the one or more distortion values corresponding to measured distortion associated with a respective reference signal of the one or more reference signals, where the one or more distortion values are independent of an interference associated with a wireless channel between the UE and the network entity.

By including or configuring the communications manager 1220 in accordance with examples as described herein, the device 1205 may support techniques for improved data throughput by estimating and reporting EVM associated with a transmitting device.

In some examples, the communications manager 1220 may be configured to perform various operations (e.g., receiving, obtaining, monitoring, outputting, transmitting) using or otherwise in cooperation with the transceiver 1210, the one or more antennas 1215 (e.g., where applicable), or any combination thereof. Although the communications manager 1220 is illustrated as a separate component, in some examples, one or more functions described with reference to the communications manager 1220 may be supported by or performed by the transceiver 1210, the processor 1235, the memory 1225, the code 1230, or any combination thereof. For example, the code 1230 may include instructions executable by the processor 1235 to cause the device 1205 to perform various aspects of EVM estimation and reporting as described herein, or the processor 1235 and the memory 1225 may be otherwise configured to perform or support such operations.

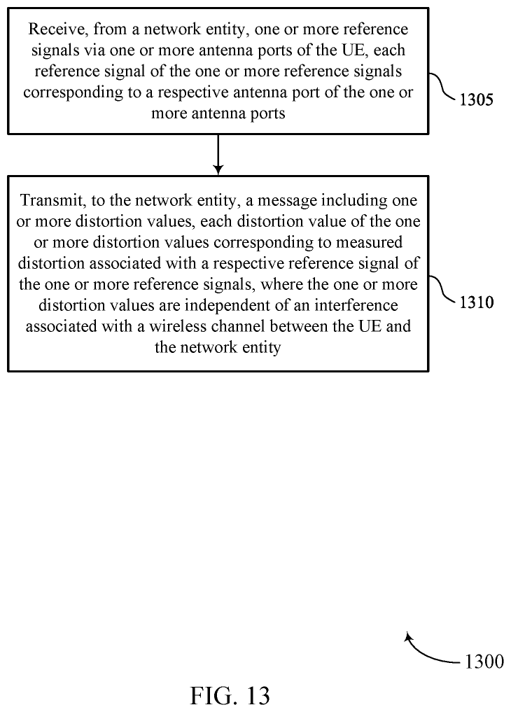

FIG. 13 shows a flowchart illustrating a method 1300 that supports EVM estimation and reporting in accordance with aspects of the present disclosure. The operations of the method 1300 may be implemented by a UE or its components as described herein. For example, the operations of the method 1300 may be performed by a UE 115 as described with reference to FIGS. 1 through 8. In some examples, a UE may execute a set of instructions to control the functional elements of the UE to perform the described functions. Additionally, or alternatively, the UE may perform aspects of the described functions using special-purpose hardware.

At 1305, the method may include receiving, from a network entity, one or more reference signals via one or more antenna ports of the UE, each reference signal of the one or more reference signals corresponding to a respective antenna port of the one or more antenna ports. The operations of block 1305 may be performed in accordance with examples as disclosed herein. In some examples, aspects of the operations of 1305 may be performed by a reference signal reception component 725 as described with reference to FIG. 7.

At 1310, the method may include transmitting, to the network entity, a message including one or more distortion values, each distortion value of the one or more distortion values corresponding to measured distortion associated with a respective reference signal of the one or more reference signals, where the one or more distortion values are independent of an interference associated with a wireless channel between the UE and the network entity. The operations of block 1310 may be performed in accordance with examples as disclosed herein. In some examples, aspects of the operations of 1310 may be performed by a EVM reporting component 730 as described with reference to FIG. 7.

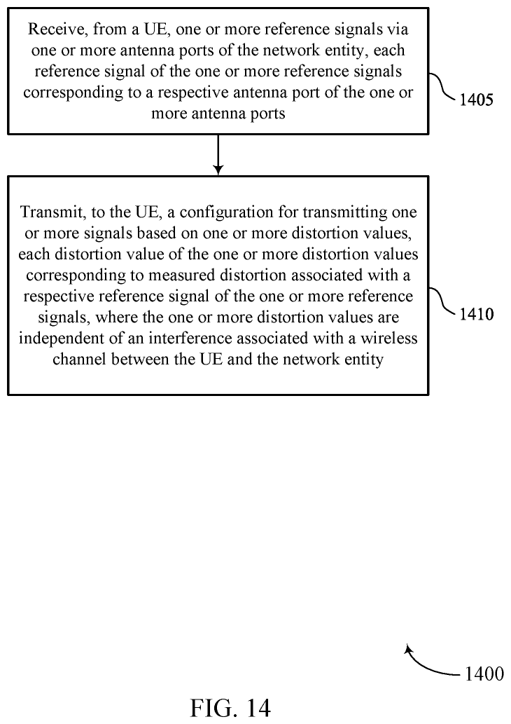

FIG. 14 shows a flowchart illustrating a method 1400 that supports EVM estimation and reporting in accordance with aspects of the present disclosure. The operations of the method 1400 may be implemented by a network entity or its components as described herein. For example, the operations of the method 1400 may be performed by a network entity as described with reference to FIGS. 1 through 4 and 9 through 12. In some examples, a network entity may execute a set of instructions to control the functional elements of the network entity to perform the described functions. Additionally, or alternatively, the network entity may perform aspects of the described functions using special-purpose hardware.

At 1405, the method may include receiving, from a UE, one or more reference signals via one or more antenna ports of the network entity, each reference signal of the one or more reference signals corresponding to a respective antenna port of the one or more antenna ports. The operations of block 1405 may be performed in accordance with examples as disclosed herein. In some examples, aspects of the operations of 1405 may be performed by a reference signal reception component 1125 as described with reference to FIG. 11.

At 1410, the method may include transmitting, to the UE, a configuration for transmitting one or more signals based on one or more distortion values, each distortion value of the one or more distortion values corresponding to measured distortion associated with a respective reference signal of the one or more reference signals, where the one or more distortion values are independent of an interference associated with a wireless channel between the UE and the network entity. The operations of block 1410 may be performed in accordance with examples as disclosed herein. In some examples, aspects of the operations of 1410 may be performed by a configuration transmission component 1130 as described with reference to FIG. 11.

The following provides an overview of aspects of the present disclosure:

Aspect 1: A method for wireless communications at a UE, comprising: receiving, from a network entity, one or more reference signals via one or more antenna ports of the UE, each reference signal of the one or more reference signals corresponding to a respective antenna port of the one or more antenna ports; and transmitting, to the network entity, a message comprising one or more distortion values, each distortion value of the one or more distortion values corresponding to measured distortion associated with a respective reference signal of the one or more reference signals, wherein the one or more distortion values are independent of an interference associated with a wireless channel between the UE and the network entity.

Aspect 2: The method of aspect 1, further comprising: measuring a respective first noise value using each antenna port of the one or more antenna ports, wherein each of the respective first noise values corresponds to a measurement of the wireless channel that is not carrying the one or more reference signals; and measuring a respective second noise value using each antenna port of the one or more antenna ports, wherein each of the respective second noise values corresponds to an estimated noise associated with each respective reference signal of the one or more reference signals, and wherein a respective distortion value of the one or more distortion values is determined based at least in part on a function of the respective first noise value and the respective second noise value.

Aspect 3: The method of aspect 2, further comprising: obtaining, for the one or more antenna ports, respective first noise covariances based at least in part on the respective first noise values and respective second noise covariances based at least in part on the respective second noise values; and obtaining the one or more distortion values based at least in part on the respective first noise covariances, the respective second noise covariances, and respective estimations of respective channels between the network entity and the one or more antenna ports.

Aspect 4: The method of aspect 1, wherein the one or more distortion values are determined according to a MRC procedure, the MRC procedure is based at least in part on a quantity of the one or more antenna ports of the UE.

Aspect 5: The method of any of aspects 1 through 4, further comprising: estimating a channel response of the wireless channel using a first antenna port of the one or more antenna ports based at least in part on decoding data associated with a first reference signal of the one or more reference signals, the first antenna port corresponding to the first reference signal, wherein a first distortion value of the one or more distortion values associated with the first reference signal is based at least in part on the estimated channel response.

Aspect 6: The method of any of aspects 1 through 5, further comprising: receiving an indication that the UE is to perform an EVM estimation procedure, wherein receiving the one or more reference signals is based at least in part on receiving the indication.

Aspect 7: The method of aspect 6, wherein receiving the indication is based at least in part on a change in an EVM associated with the network entity, a change in one or more channel conditions associated with the wireless channel, a noise limitation associated with the UE, or a combination thereof.

Aspect 8: The method of any of aspects 1 through 7, wherein each reference signal of the one or more reference signals comprises a CSI-RS or a DMRS.

Aspect 9: The method of any of aspects 1 through 7, wherein each reference signal of the one or more reference signals comprises a transport block that is encoded onto a shared data channel.

Aspect 10: The method of any of aspects 1 through 9, wherein receiving the one or more reference signals comprises: receiving the one or more reference signals via one or more frequency resources dedicated to performing EVM estimation.

Aspect 11: The method of any of aspects 1 through 10, wherein receiving the one or more reference signals comprises: receiving the one or more reference signals via a bandwidth associated with the wireless channel, each reference signal of the one or more reference signals spanning across the bandwidth; or receiving each reference signal of the one or more reference signals via a respective bandwidth part of the bandwidth.

Aspect 12: The method of any of aspects 1 through 11, wherein each antenna port of the one or more antenna ports is configured according to a FDD pattern, a TDD pattern, or both.

Aspect 13: The method of any of aspects 1 through 12, wherein the message comprises a MAC-CE or a RRC signal, and the message is a periodic message or an aperiodic message.

Aspect 14: The method of any of aspects 1 through 13, wherein each distortion value of the one or more distortion values comprises a decibel value, a percentage, a difference between the measured distortion of the respective reference signal and a prior distortion measurement using the respective antenna port, a difference between the measured distortion of the respective reference signal and a second measured distortion of a second reference signal of the one or more reference signals, or a combination thereof.

Aspect 15: The method of any of aspects 1 through 14, further comprising: receiving one or more signals from the network entity based at least in part on transmitting the message, wherein an output power, a waveform, a rank, a precoding configuration, a beamforming configuration, or any combination thereof associated with the one or more signals is based at least in part on the one or more distortion values.

Aspect 16: A method for wireless communications at a network entity, comprising: receiving, from a UE, one or more reference signals via one or more antenna ports of the network entity, each reference signal of the one or more reference signals corresponding to a respective antenna port of the one or more antenna ports; and transmitting, to the UE, a configuration for transmitting one or more signals based at least in part on one or more distortion values, each distortion value of the one or more distortion values corresponding to measured distortion associated with a respective reference signal of the one or more reference signals, wherein the one or more distortion values are independent of an interference associated with a wireless channel between the UE and the network entity.

Aspect 17: The method of aspect 16, further comprising: receiving, from the UE, a capability report indicating a capability of the UE to transmit the one or more reference signals via one or more bandwidth parts of a bandwidth associated with the wireless channel.

Aspect 18: The method of any of aspects 16 through 17, wherein the configuration indicates one or more physical layer parameters for transmitting the one or more signals, the one or more physical layer parameters comprising a precoding configuration, a quantity of spatial layers, or both.

Aspect 19: The method of any of aspects 16 through 18, further comprising: receiving, from the UE, a request to perform an EVM estimation procedure, wherein receiving the one or more reference signals is based at least in part on receiving the request.

Aspect 20: The method of any of aspects 16 through 19, wherein each reference signal of the one or more reference signals comprises a CSI-RS or a DMRS.

Aspect 21: The method of any of aspects 16 through 20, wherein each reference signal of the one or more reference signals comprises a transport block that is encoded onto a shared data channel.

Aspect 22: An apparatus for wireless communications at a UE, comprising at least one processor; at least one memory coupled with the at least one processor; and instructions stored in the at least one memory and executable by the at least one processor to cause the apparatus to perform a method of any of aspects 1 through 15.

Aspect 23: An apparatus for wireless communications at a UE, comprising at least one means for performing a method of any of aspects 1 through 15.

Aspect 24: A non-transitory computer-readable medium storing code for wireless communications at a UE, the code comprising instructions executable by a processor to perform a method of any of aspects 1 through 15.

Aspect 25: An apparatus for wireless communications at a network entity, comprising at least one processor; at least one memory coupled with the at least one processor; and instructions stored in the at least one memory and executable by the at least one processor to cause the apparatus to perform a method of any of aspects 16 through 21.

Aspect 26: An apparatus for wireless communications at a network entity, comprising at least one means for performing a method of any of aspects 16 through 21.

Aspect 27: A non-transitory computer-readable medium storing code for wireless communications at a network entity, the code comprising instructions executable by a processor to perform a method of any of aspects 16 through 21.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration). Any functions or operations described herein as being capable of being performed by a processor may be performed by multiple processors that, individually or collectively, are capable of performing the described functions or operations.

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media. Any functions or operations described herein as being capable of being performed by a memory may be performed by multiple memories that, individually or collectively, are capable of performing the described functions or operations.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

As used herein, including in the claims, the article “a” before a noun is open-ended and understood to refer to “at least one” of those nouns or “one or more” of those nouns. Thus, the terms “a,” “at least one,” “one or more,” “at least one of one or more” may be interchangeable. For example, if a claim recites “a component” that performs one or more functions, each of the individual functions may be performed by a single component or by any combination of multiple components. Thus, the term “a component” having characteristics or performing functions may refer to “at least one of one or more components” having a particular characteristic or performing a particular function. Subsequent reference to a component introduced with the article “a” using the terms “the” or “said” may refer to any or all of the one or more components. For example, a component introduced with the article “a” may be understood to mean “one or more components,” and referring to “the component” subsequently in the claims may be understood to be equivalent to referring to “at least one of the one or more components.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. An apparatus for wireless communications at a user equipment (UE), comprising:
one or more processors;
memory coupled with the one or more processors; and
instructions stored in the memory and executable by the one or more processors to cause the apparatus to:
receive, from a network entity, one or more reference signals via one or more antenna ports of the UE, each reference signal of the one or more reference signals corresponding to a respective antenna port of the one or more antenna ports; and
transmit, to the network entity, a message comprising one or more distortion values, each distortion value of the one or more distortion values corresponding to measured distortion associated with a respective reference signal of the one or more reference signals, wherein the one or more distortion values are independent of an interference associated with a wireless channel between the UE and the network entity.

2. The apparatus of claim 1, wherein the instructions are further executable by the one or more processors to cause the apparatus to:
measure a respective first noise value using each antenna port of the one or more antenna ports, wherein each of the respective first noise values corresponds to a measurement of the wireless channel that is not carrying the one or more reference signals; and
measure a respective second noise value using each antenna port of the one or more antenna ports, wherein each of the respective second noise values corresponds to an estimated noise associated with each respective reference signal of the one or more reference signals, and wherein a respective distortion value of the one or more distortion values is determined based at least in part on a function of the respective first noise value and the respective second noise value.

3. The apparatus of claim 2, wherein the instructions are further executable by the one or more processors to cause the apparatus to:
obtain, for the one or more antenna ports, respective first noise covariances based at least in part on the respective first noise values and respective second noise covariances based at least in part on the respective second noise values; and
obtain the one or more distortion values based at least in part on the respective first noise covariances, the respective second noise covariances, and respective estimations of respective channels between the network entity and the one or more antenna ports.

4. The apparatus of claim 1, wherein the one or more distortion values are determined according to a maximal-ratio combining procedure, and wherein the maximal-ratio combining procedure is based at least in part on a quantity of the one or more antenna ports of the UE.

5. The apparatus of claim 1, wherein the instructions are further executable by the one or more processors to cause the apparatus to:
estimate a channel response of the wireless channel using a first antenna port of the one or more antenna ports based at least in part on decoding data associated with a first reference signal of the one or more reference signals, the first antenna port corresponding to the first reference signal, wherein a first distortion value of the one or more distortion values associated with the first reference signal is based at least in part on the estimated channel response.

6. The apparatus of claim 1, wherein the instructions are further executable by the one or more processors to cause the apparatus to:
receive an indication that the UE is to perform an error vector magnitude estimation procedure, wherein receiving the one or more reference signals is based at least in part on receiving the indication.

7. The apparatus of claim 6, wherein receiving the indication is based at least in part on a change in an error vector magnitude associated with the network entity, a change in one or more channel conditions associated with the wireless channel, a noise limitation associated with the UE, or a combination thereof.

8. The apparatus of claim 1, wherein each reference signal of the one or more reference signals comprises a channel state information reference signal or a demodulation reference signal.

9. The apparatus of claim 1, wherein each reference signal of the one or more reference signals comprises a transport block that is encoded onto a shared data channel.

10. The apparatus of claim 1, wherein the instructions to receive the one or more reference signals are executable by the one or more processors to cause the apparatus to:
receive the one or more reference signals via one or more frequency resources dedicated to performing error vector magnitude estimation.

11. The apparatus of claim 1, wherein the instructions to receive the one or more reference signals are executable by the one or more processors to cause the apparatus to:
receive the one or more reference signals via a bandwidth associated with the wireless channel, each reference signal of the one or more reference signals spanning across the bandwidth; or
receive each reference signal of the one or more reference signals via a respective bandwidth part of the bandwidth.

12. The apparatus of claim 1, wherein each antenna port of the one or more antenna ports is configured according to a frequency domain duplexing pattern, a time domain duplexing pattern, or both.

13. The apparatus of claim 1, wherein the message comprises a media access control control element or a radio resource control signal, and wherein the message is a periodic message or an aperiodic message.

14. The apparatus of claim 1, wherein each distortion value of the one or more distortion values comprises a decibel value, a percentage, a difference between the measured distortion of the respective reference signal and a prior distortion measurement using the respective antenna port, a difference between the measured distortion of the respective reference signal and a second measured distortion of a second reference signal of the one or more reference signals, or a combination thereof.

15. The apparatus of claim 1, wherein the instructions are further executable by the one or more processors to cause the apparatus to:
receive one or more signals from the network entity based at least in part on transmitting the message, wherein an output power, a waveform, a rank, a precoding configuration, a beamforming configuration, or any combination thereof associated with the one or more signals is based at least in part on the one or more distortion values.

16. An apparatus for wireless communications at a network entity, comprising:
one or more processors;
memory coupled with the one or more processors; and
instructions stored in the memory and executable by the one or more processors to cause the apparatus to:
receive, from a user equipment (UE), one or more reference signals via one or more antenna ports of the network entity, each reference signal of the one or more reference signals corresponding to a respective antenna port of the one or more antenna ports; and
transmit, to the UE, a configuration for transmitting one or more signals based at least in part on one or more distortion values, each distortion value of the one or more distortion values corresponding to measured distortion associated with a respective reference signal of the one or more reference signals, wherein the one or more distortion values are independent of an interference associated with a wireless channel between the UE and the network entity.

17. The apparatus of claim 16, wherein the instructions are further executable by the one or more processors to cause the apparatus to:
receive, from the UE, a capability report indicating a capability of the UE to transmit the one or more reference signals via one or more bandwidth parts of a bandwidth associated with the wireless channel.

18. The apparatus of claim 16, wherein the configuration indicates one or more physical layer parameters for transmitting the one or more signals, the one or more physical layer parameters comprising a precoding configuration, a quantity of spatial layers, or both.

19. The apparatus of claim 16, wherein the instructions are further executable by the one or more processors to cause the apparatus to:
receive, from the UE, a request to perform an error vector magnitude estimation procedure, wherein receiving the one or more reference signals is based at least in part on receiving the request.

20. (canceled)

21. (canceled)

22. A method for wireless communications at a user equipment (UE), comprising:
receiving, from a network entity, one or more reference signals via one or more antenna ports of the UE, each reference signal of the one or more reference signals corresponding to a respective antenna port of the one or more antenna ports; and
transmitting, to the network entity, a message comprising one or more distortion values, each distortion value of the one or more distortion values corresponding to measured distortion associated with a respective reference signal of the one or more reference signals, wherein the one or more distortion values are independent of an interference associated with a wireless channel between the UE and the network entity.

23-30. (canceled)
